(19) United States
(12) Patent Application Publication
(10) Pub. No.: US 2005/0105917 A1
(43) Pub. Date: May 19, 2005

(54) Optical modulating apparatus

(76) Inventors: Hidehiko Narusawa, Machida (JP); Tetsuya Kiyonaga, Kawasaki (JP)

Correspondence Address: SWIDLER BERLIN LLP, 3000 K STREET, NW, BOX IP, WASHINGTON, DC, 20007, US

(21) Appl. No.: 10/959,487

(22) Filed: Oct. 7, 2004

(30) Foreign Application Priority Data
Nov. 14, 2003 (JP) 2003-384471

(51) Int. Cl. H04B 10/04

(52) U.S. Cl. 398/183

(57) ABSTRACT

The direct control of a change in output amplitude of the modulator driver resulting from changes in the ambient environment or by aging is difficult because deterioration is generated in the drive waveform under the condition that the drive signal of the radio frequency is output from the modulator driver of the Mach-Zehnder modulator. A low frequency element included in the modulator output is monitored by superimposing the low frequency signals under the in-phase condition to two envelopes corresponding to the H input and L input of the drive signal. Amplitude of the drive signal outputted from the modulator driver can be adjusted without deterioration of the drive waveform.

### BACKGROUND OF THE INVENTION

1. Field of the Invention

The present invention relates to an optical modulating apparatus comprising a Mach-Zehnder type optical modulator.

2. Description of the Related Art

In an optical communication system, communications are performed by transmitting optical pulse trains (signal lights) which have been modulated with a signal to a transmission medium, for example, an optical fiber, or the like. Transmission quality in the optical communication system is expressed with a bit error rate, namely an error rate of signal bit trains demodulated with a signal light in the receiving apparatus.

When a signal light is transmitted for a long distance with an optical fiber, an optical pulse of the signal light is distinctively compressed or expanded with chirp of the optical wavelength and dispersion of the optical fiber as the transmission medium. Since the change of signal waveform affects the transmission quality expressed as a bit error rate, a code discrimination threshold for determining 0 and 1 for decoding of a signal light is controlled, in order to reduce the bit error rate, to the optimum value for the receiving waveform.

FIG. 24 illustrates the optimum threshold value for a pulse-compressed signal waveform. Since a duty ratio of the pulse is reduced because of pulse compression, the optimum threshold value Pb for the pulse-compressed signal waveform becomes lower than the optimum threshold value Pa for the non pulse-compressed signal waveform. When the average intensity of H-level signal light is defined as Phigh and the average intensity of L-level signal light as Plow, a code error rate is significantly changed with Plow when a code discrimination threshold is lowered with pulse compression.

Here, since an extinction ratio of signal waveform is expressed as
Ex=20 log(Phigh/Plow)(dB), (1)
sufficient extinction ratio must be acquired to reduce the code error rate. Namely, in order to reduce the code error rate and provide sufficient transmission quality, it is required to select the optimum code discrimination threshold value with the receiving apparatus and to provide a higher extinction ratio of the signal light transmitted with a transmission apparatus.

For the long-haul transmission of an optical signal, an optical transmitter mainly introduces continuous wave (CW) and an external modulation system for modulating the light output from a light source with an external modulator. As the external modulator, for example, a Mach-Zehnder (MZ) type modulator formed on a lithium niobate (LN:LiNbO₃) substrate is used.

FIG. 13 is a schematic diagram of an Mz modulator 2 using a Z-cut LN substrate. In the MZ modulator illustrated in FIG. 13, waveguides 22A, 22B, Y branching waveguides 23A, 23B, parallel waveguides 24A, 24B are formed on the LN substrate 21. Moreover, a signal electrode 25A and a ground electrode 25B are also formed on a buffer layer. The buffer layer 11A prevents that the light propagated through the parallel waveguides 24A, 24B from being absorbed with the signal electrode 25A and ground electrode 25B.

The signal electrode 25A is formed as a traveling wave electrode terminated with a resistor 210 and a radio frequency (RF) signal is impressed from a signal input port 220A.

The light input to the Mz modulator 2 is branched, with the Y branching waveguide 23A, to two parallel waveguides 24A, 24B. Since the refractive indices of the parallel waveguides 24A, 24B are different depending on the RF signal applied to the signal electrode 25A, a phase difference is generated between the light propagated through the parallel waveguide 24A and the light propagated through the parallel waveguide 24B and the light multiplexed with the Y branching waveguide 23B is output from the optical waveguide 22B.

FIG. 14(a) illustrates a relationship between intensity Pin of the light input to the waveguide 22A and intensity Pout of the light output from the waveguide 22B for a phase difference θ of the lights propagated through the parallel waveguides 24A, 24B. Intensity of the output light changes depending on the phase difference θ, the minimum intensity is obtained when the phase difference θ is equal to an odd number times of π, the maximum intensity is obtained when the phase difference θ is equal to an even number times of π, and the relationship between the Pin and Pout can be expressed, when loss can be neglected, as follows with θ varied as a parameter:
Pout=(Pin/2)(1+sin θ) (2)

FIG. 14(b) illustrates a relationship between a modulation voltage, namely a voltage (Vin) of RF signal applied to the signal electrode 25A and a phase difference θ. Phase difference θ of the MZ modulator 2 is proportional to the modulation voltage Vin. Moreover, the modulation voltage at which the phase difference θ becomes zero is called an offset voltage Voff.

FIG. 14(c) illustrates a relationship between a modulation voltage and an output light intensity. When the modulation voltage becomes the offset voltage Voff, the output light intensity of the Mz modulator becomes a minimum. The modulation voltage for changing the output light intensity to the maximum value from the minimum value is particularly called Vπ(Vpp). The voltage Vπ results in a difference of π in the phases due to the modulation voltage and the relationship between Pin and Pout can be expressed, when loss may be neglected, as follows with the modulation voltage Vin varied as a parameter:
Pout=(Pin/2)[1+sin 2π{(Vin−Voff)/Vπ}] (3)

In order to obtain the maximum extinction ratio and the minimum inter-symbol interference of the output light of the MZ modulator, the maximum and minimum values of modulation signal Vin must correspond to the maximum and minimum (or opposite thereof) values of output light intensity Pout. That is, when an operational voltage Vop(V) is set to an intermediate value between the voltage which results in the maximum output light intensity and the voltage which results in the minimum output light intensity as illustrated in FIG. 15, this operational voltage must be controlled to make a driver output amplitude Vdrv(Vpp) of the modulation signal output from a modulator driver equal to Vπ(Vpp), while a DC bias Vmz(V) is equal to Vop(V).

Since the operational voltage Vop of the MZ modulator varies depending on temperature, it is required to vary the DC bias Vmz in accordance with variation of the operational voltage Vop. Here, a technique to control the DC bias of the MZ modulator with superimposition of a low frequency signal to an input signal is also known, for example, as shown in Japanese Published Unexamined Patent Application No. 1991-251815.

FIG. 16 illustrates an optical modulating apparatus 19 for controlling the DC bias Vmz of the modulator driver. The optical modulating apparatus 19 illustrated in FIG. 16 comprises an MZ modulator 2, a modulator driver 31, a bias tee (BT) 41, a terminating section 42, an amplifying section 43, a branching section 51, a monitor photodetector (PD) 52, an amplifying section 53, an oscillating section 61, a polarity switching section 62, an amplifying section 63, a phase comparing section 73, a low-pass filter (LPF) 72, and a band-pass filter (BPF) 71.

A transmitting signal is input to the modulator driver 31 from an external source and is then amplified up to a sufficient amplitude for driving the MZ modulator 2. Thereafter, only the AC element Vdrv of the amplified transmitting signal (drive signal) is supplied to the Mz modulator 2 through a capacitor 32. Meanwhile, only the DC element Vmz of the drive signal of the MZ modulator is supplied from the amplifying section 43 through the bias tee 41. The terminating section 42 operates as a terminating circuit of the output circuit of the modulator driver 31.

When the MZ modulator 2 is driven with the bias voltage supplied from the modulator driver 31 for amplifying the transmitting signal and the bias tee 41, the light input from the external CW light source is intensity-modulated and is then output. The branching section 51 branches the output light of the MZ modulator to an output of the optical modulating apparatus 19 and an input of the PD 52 and the branched output light of the MZ modulator 2 is then converted to an electrical signal with the monitor PD 52. A high band cut-off frequency of the PD 52 is sufficiently lower than a bit rate of the transmitting data signal and a current which is proportional to an average value of the signal light output of the Mz modulator 2 is output.

Next, auto-bias control (ABC) of the Mz modulator illustrated in FIG. 16 will be described.

The oscillating section 61 generates a bias control pilot signal of the frequency f1 and then inputs this bias control pilot signal to the phase comparing section 73 and the polarity switching section 62. The bias control pilot signal input to the polarity switching section 62 is inverted in polarity as required and is then amplified with the amplifying section 63. Thereafter, the bias control pilot signal is applied to an amplitude control terminal of the modulator driver 3 1.

With the bias control pilot signal applied to the modulator driver 31, an output signal of the modulator driver 31 is amplitude-modulated with the frequency f1 and is then input to the MZ modulator 2 through the capacitor 32.

An output signal of the modulator driver 31 for driving the Mz modulator is amplitude-modulated with the frequency f1 but the condition of the output light of the MZ modulator is different depending on the relationship between the DC bias Vmz and operational voltage Vop.

FIG. 17 illustrates a modulator driving signal waveform and a modulator output light waveform when the DC bias Vmz impressed on the MZ modulator 2 is equal to the operational voltage Vop of the MZ modulator 2. When the DC bias Vmz and operational voltage Vop are equal, the maximum and minimum voltages of the modulator drive signal correspond respectively to the bottom and peak voltages of the modulator characteristic. Accordingly, the elements of the frequency f1 or 2f1 appearing on the envelopes of the maximum intensity and minimum intensity of the output signal light are inverted in the phase and thereby the output light waveforms appear as symmetrical waveforms.

Therefore, when the DC bias Vmz and operational voltage Vop are equal, the element of frequency f1 does not appear in an average value of the output light waveform and the element of frequency f1 does not appear on an output current from the PD 52.

Meanwhile, the modulator drive signal waveform and modulator output light waveform, when the DC bias Vmz and operational voltage Vop are not equal, are illustrated in FIG. 18 (Vmz≠Vop) and FIG. 19 (Vmz≠Vop). When Vmz is not equal to Vop, the maximum and minimum modulator drive signals deviate from the peak and bottom voltages of the modulator characteristic. Accordingly, the element of frequency f1 is included in the average value of the optical output waveform and the element of frequency f1 is included also in the output current of the PD 52.

Since the element of frequency f1 included in the output current of PD 52 varies with the polarity depending on the deviation direction of Vmz for Vop and the amplitude proportional to deviation of Vmz for Vop. Accordingly, the optimum DC bias can be obtained through feedback control of the DC bias Vmz depending on the intensity of element of frequency f1.

An output current of the PD 52 is current/voltage converted with amplifying section 53 for elimination of the elements other than that of frequency f1 with the BPF 71. Thereafter, the output current is then compared, within the phase comparing section 73, in phase with the bias control pilot signal of frequency f1 output from the oscillating section 61.

A voltage of polarity and amplitude depending on the amount of deviation and direction of Vmz for Vop is output from the phase comparing section 73, this voltage is then smoothed with the LPF 72 and amplified with the amplifying section 43. Finally, this voltage is applied to the MZ modulator 2 via the bias tee 41.

When the polarity of the bias control pilot signal is set with the polarity switching section 62 to realize negative feedback of Vmz with the route passing through the MZ modulator 2, phase comparing section 73 and MZ modulator 2, Vmz can be stabilized with the structure described above when the DC bias Vmz becomes equal to the operational voltage Vop. Accordingly, the DC bias can be set to the optimum characteristic of the MZ modulator 2 and the extinction ratio of the modulated signal light can be increased.

In the structure described above, an input signal of the MZ modulator is modulated with the bias control pilot signal. However, the DC bias Vmz can be controlled to become equal to the operational voltage Vop by controlling the bias modulation of the input signal of the MZ modulator with the vias control pilot signal in view of obtaining the maximum bias control pilot signal element output from the PD.

The DC bias Vmz of the MZ modulator can be varied in accordance with variation of the operational voltage Vop due to the variation of temperature or the like with bias control of the MZ modulator as described above.

Meanwhile, it is important for the modulator to realize the optimum operation in order to increase the extinction ratio of the output signal light under the operating condition that that not only the operational voltage Vop is equal to the DC bias Vmz but also the output amplitude Vdrv(Vpp) of the modulator driver is equal to Vπ(Vpp).

Since the value of Vπ also includes fluctuation due to the manufacture as in the case of operational voltage Vop, the initial adjustment is performed to provide the maximum extinction ratio of the optical output waveform in order to make equal Vdrv to Vπ. Variation of Vπ in the MZ modulator due to the change of environment or variation thereof with the aging are small but the output amplitude Vdrv of the modulator driver is influenced by variations in amplitude, temperature and power supply voltage of the input signal and also allows variation with aging.

FIGS. 23(a) and 23(b) illustrate relationships between output amplitude Vdrv and output signal light. When the output amplitude Vdrv is equal to Vπ, noise included in the input signal can be compressed, to a certain degree, with the modulation characteristic because the H input and L input of the input signal correspond to the peak or bottom of the modulation characteristic of the MZ modulator as illustrated in FIG. 23(a).

On the other hand, when the output amplitude Vdrv is not equal to Vπ, since any effect of noise compression is never produced due to the modulation characteristic of the MZ modulator as illustrated in FIG. 23(b), noise included in the input signal is superimposed on the output signal light waveform.

Accordingly, it is important for prevention of deterioration of the output signal light waveform and the increase of the extinction ratio to realize optimum operation of the MZ modulator. Therefore, not only the bias voltage Vmz is controlled in accordance with the operational voltage Vop but also an output Vdrv of the modulator driver is stabilized.

However, frequency of the drive signal output from the modulator driver is identical to the frequency of the transmitting signal used to modulate the CW light input to the MZ modulator and it is difficult to stabilize directly the output Vdr of the modulator driver.

For example, FIG. 20(a) illustrates a structure for controlling the output amplitude Vdrv of the drive signal by detecting an amplitude of the drive signal output from the modulator driver 31 with a resistor 311A and an amplitude detecting circuit 310, amplifying the amplitude detection voltage with an amplifier 315 and then feeding back this amplitude detection voltage to an amplitude control terminal of the modulator driver 31.

However, a radio frequency signal output from the modulator driver is input, as illustrated in FIG. 20(b), to the MZ modulator through a microstrip line 316A of 50Ω and an impedance of the strip line 316A is disturbed and thereby a reflected wave is generated by detection of amplitude using the resistor 311A.

Namely, a reflected wave is generated and a waveform of the drive signal is deteriorated by detection of an output amplitude of the drive signal of the modulator driver.

Moreover, a problem arises in that the detected voltage varies due to a signal pattern of the transmitting signal, and the output amplitude Vdrv cannot be measured accurately because a diode 314 of the amplitude detecting circuit 310 has the radio frequency characteristic as illustrated in FIG. 21(a). For example, when the transmitting signal is formed of a signal pattern wherein the identical bits are allocated continuously as illustrated in FIG. 21(b) and has the frequency fa, or of a signal pattern wherein the levels 0 and 1 are alternately repeated as illustrated in FIG. 21(c) and has the frequency fb, a difference is generated in the detected voltage of this transmitting signal even when the output amplitude is identical, and the output amplitude cannot be detected accurately.

Namely, when an output amplitude is controlled by detecting an output amplitude of the drive signal of the modulator driver, it is probable that the frequency characteristic of the amplitude detection circuit generates a problem.

As a method of artificially stabilizing an output amplitude of the drive signal of the modulator driver, it is known to provide an FET drain current of a driver output section as a fixed current as illustrated in FIG. 22(a). However, since an output characteristic (α) of the modulator driver is influenced by variation of temperature or the like and change by aging as illustrated in FIG. 22(b), it will generate an error against the ideal characteristic (β) which is linear to the current Id and therefore it is difficult to stabilize the output amplitude Vdrv.

### SUMMARY OF THE INVENTION

The present invention has been proposed to solve the problems described above and an optical modulating apparatus of the first invention is characterized in comprising a modulating means for modulating an input light and outputting an optical signal, a first signal transmitting section for outputting a signal of a first frequency, a second signal transmitting section for outputting a signal of a second frequency, a modulator driving section for inputting a transmitting data and the signal of the first frequency, outputting a drive signal depending on the transmitting data to the modulating section and superimposing the signal of the first frequency to the drive signal so that the signal of the first frequency appears in the reverse phase on the two envelopes of the drive signal, a bias applying section for inputting the signal of the second frequency and giving a bias in which the signal of the second frequency is superimposed to the modulating section, and a monitoring means for branching an output light of the modulating means and outputting a monitor signal converted to an electrical signal, wherein the bias is controlled on the basis of the first frequency element included in the monitor signal and an amplitude of the drive signal is controlled on the basis of the second frequency element included in the monitor signal.

An optical modulating apparatus of the second embodiment is characterized in comprising a modulating means for modulating an input light and outputting an optical signal, a first signal transmitting section for outputting a signal of a first frequency, a second signal transmitting section for outputting a signal of a second frequency, a modulator driving section for inputting a transmitting data and the signal of the first frequency, outputting a drive signal depending on the transmitting data to the modulator by mixing the drive signal and the signal of the second frequency and superimposing the signal of the first frequency to said drive signal so that the signal of the first frequency appears in the reverse phase on the two envelopes of the drive signal, a bias applying section for giving a bias to the modulating means, and a-monitor means for branching an output light of the modulating means and outputting a monitor signal converted to an electrical signal, wherein the bias is controlled on the basis of the first frequency element included in the monitor signal and an amplitude of the drive signal is controlled on the basis of the second frequency element included in the monitor signal.

An optical modulating apparatus of the third embodiment relates to the optical modulating apparatus according to the claim 1 or 2 and is characterized in that the modulator driving section inputs the signal of the first frequency and mixes the signal of the first frequency to the drive signal in order to cancel the firs frequency element in the single side of the envelopes of the drive signal.

An optical modulating apparatus of the fourth embodiment relates to the optical modulating apparatus according to the claim 1 or 2 and is characterized in that the first signal transmitting section inputs the signal of the first frequency to the bias applying section and the bias applying section modulates the bias with the first frequency in order to cancel the first frequency element in the single side of the envelopes of the drive signal.

An optical modulating apparatus of the fifth embodiment relates to the optical modulating apparatus according to the claim 1 or 2 and is characterized in that the first signal transmitting section inputs the signal of the first frequency to the monitor section and the monitor section mixes the signal of the first frequency to the monitor signal in order to cancel the first frequency element in the single side of the envelopes of the optical modulating means.

An optical modulating apparatus of the sixth embodiment relates to the optical modulating apparatus according to the claims 1 to 5 and is characterized in that the second signal transmitting section inputs the signal of the second frequency to the modulator driving section, the modulator driving section modulates the drive signal with the second frequency and provides an output, and an amplitude of the drive signal is controlled by controlling intensity of the signal of the second frequency input to the modulator driving section.

An optical modulating apparatus of the seventh embodiment relates to the optical modulating apparatus according to the claims 1 to 5 and is characterized in that the second signal transmitting section inputs the signal of the second frequency to the monitor section, the monitor section mixes the signal of the second frequency to the monitor signal, and an amplitude of the drive signal is controlled by controlling intensity of the signal of the second frequency input to the monitor section.

An optical modulating apparatus of the seventh embodiment is characterized in comprising a Mach-Zehnder type modulator for modulating an input light and outputting an optical signal, a first signal transmitting section for outputting a signal of a first frequency, a second signal transmitting section for outputting a signal of a second frequency, a modulator driving section for inputting a transmitting data and the signal of the first frequency, outputting a drive signal depending on the transmitting data to the modulator, and superimposing the signal of the first frequency to the drive signal so that the signal of the first frequency appears in the reverse phase on the two envelopes of the drive signal, a bias applying section for inputting the signal of the second frequency and giving a bias in which the signal of the second frequency is superimposed to the modulator, and a monitor means for branching an output light of the modulator and outputting a monitor signal converted to an electrical signal, wherein the bias is controlled on the basis of the periodical characteristic of the modulator and the first frequency element included in the monitor signal and an amplitude of the drive signal is controlled on the basis of the periodical characteristic of the modulator and the second frequency element included in the monitor signal.

The optical modulating apparatus of the present invention is capable of adjusting, without deterioration of a drive waveform, an amplitude of a drive signal output from the modulator driving section by superimposing a signal of a first frequency in reverse phase to the two envelopes of a drive signal and then monitoring a first frequency element included in an modulator output. Thereby, an extinction ratio of the modulator output can be stabilized for a long period of time.

Moreover, since a desired offset can be given to the converging point of any one of input bias and input amplitude of the modulator or both of these elements by adding the first and/or second frequency element to the drive signal, bias applying section and monitoring section, an output signal waveform of the modulator can be corrected.

Particularly, an output signal waveform of the modulator can be corrected by concurrent control of input bias and input amplitude of the modulator in accordance with the periodical characteristic of the Mach-Zehnder modulator.

### BRIEF DESCRIPTION OF THE DRAWINGS

FIG. 1 is an exemplary diagram illustrating the optical modulating apparatus of the present invention.

FIG. 2 is an exemplary diagram illustrating the condition of output signal light where the amplitude control pilot signal is superimposed.

FIG. 3 is an exemplary diagram illustrating the condition of output signal light where the amplitude control pilot signal is superimposed.

FIG. 4 is an exemplary diagram illustrating the condition of output signal light where the amplitude control pilot signal is superimposed.

FIG. 5 is an exemplary diagram illustrating the optical modulating apparatus of the present invention.

FIG. 6 is an exemplary diagram illustrating the optical modulating apparatus of the present invention.

FIGS. 7(a), 7(b), and 7(c) are exemplary diagrams illustrating the conditions where a low frequency signal is superimposed to the modulator driving signal.

FIG. 8 is an exemplary diagram illustrating the optical modulating apparatus of the present invention.

FIG. 9 is an exemplary diagram illustrating the optical modulating apparatus of the present invention.

FIG. 10 is an exemplary diagram illustrating the optical modulating apparatus of the present invention.

FIG. 11 is an exemplary diagram illustrating the optical modulating apparatus of the present invention.

FIG. 12 is an exemplary diagram illustrating the optical modulating apparatus of the present invention.

FIG. 13 is an exemplary diagram illustrating the MZ modulator.

FIGS. 14(a), 14(b), and 14(c) are exemplary diagrams illustrating the characteristics of the MZ modulator.

FIG. 15 is an exemplary diagram illustrating the modulation characteristic of the MZ modulator and condition of the input signal.

FIG. 16 is an exemplary diagram illustrating the optical modulating apparatus based on the prior arts.

FIG. 17 is an exemplary diagram illustrating the condition of output signal light due to the superimposing of the bias pilot signal.

FIG. 18 is an exemplary diagram illustrating the condition of output signal light due to the superimposing of the bias pilot signal.

FIG. 19 is an exemplary diagram illustrating the condition of output signal light due to the superimposing of the bias pilot signal.

FIG. 20 is an exemplary diagram illustrating an amplitude detecting constitution of the modulator driver.

FIGS. 21(a) and 21(b) are exemplary diagrams illustrating changes of the detected voltage of diode with the pattern of input signal.

FIGS. 22(a) and 22(b) are exemplary diagrams illustrating constitutions for stabilizing an output of the modulator driver.

FIGS. 23(a) and 23(b) are exemplary diagrams for illustrating influence of the drive signal amplitude on the output signal light.

FIG. 24 is an exemplary diagram illustrating relationships among the pulse waveform, threshold value and extinction ratio.

FIG. 25 is an exemplary diagram illustrating the condition where one level of the input signal is fixed to the bottom voltage of the modulation characteristic.

### DETAILED DESCRIPTION OF THE PREFERRED EMBODIMENTS

### Description of the First Embodiment

The optical modulating apparatus according to the first embodiment of the present invention is illustrated in FIG. 1.

The optical modulating apparatus 11A according to the first embodiment is constituted with an MZ modulator 2, a modulator driving section 3, a bias applying section 4, a monitoring section 5, a bias control pilot signal transmitting section 6, a bias control section 7, an amplitude control pilot signal transmitting section 8, and an amplitude control section 9.

The modulator driving section 3 includes a modulator driver 31, a capacitor 32 and a mixing section 35. The mixing section mixes an amplitude control signal output from the amplitude control section 9 and a bias control pilot signal output from the bias control pilot signal transmitting section 6 and then outputs the mixed signal to an amplitude control terminal of the modulator driver 31. The modulator driver 31 amplifies the transmitting signal input from the external side up to the amplitude enough for driving the MZ modulator 2 and also performs amplitude modulation with the signal input to the amplitude control terminal.

The bias applying section 4 is constituted with a bias tee 41, a terminating section 42, an amplifying section 43 and a mixing section 45. The terminating section 42 terminates the drive signal applied to the electrode of the MZ modulator 2 from the modulator driver 31. A bias voltage is applied to the MZ modulator 2 with an output of the amplifying section 43 and bias tee 41. The mixing section 45 mixes the amplitude control pilot signal output from the amplitude control pilot signal transmitting section 8 and the bias control signal output from the bias control section 7 and outputs the mixed signal to the amplifying section 43.

The monitor section 5 is constituted with a branching section 51, a PD 52 and an amplifying section 53. The branching section 51 branches an output light of the MZ modulator 2 to an output of the optical modulating apparatus 11A and an input of the PD 52 in order to convert, with the PD 52, the branched output light of the MZ modulator 2 to an electrical signal. The monitor signal output from the PD 52 is amplified with the amplifying section 53 and is then input to the bias control section 7 and amplitude control section 9.

The bias control pilot signal transmitting section 6 is constituted with an oscillating section 61, a polarity switching section (POL) 62, and an amplifying section 63. The oscillating section 61 generates the bias control pilot signal of frequency f1 and outputs this signal to the bias control section 7 and polarity switching section 62. The bias control pilot signal input to the polarity switching section 62 is inverted in the polarity as required, amplified with the amplifying section 63 and is then output to the modulator driving section 3.

The bias control section 7 is constituted with a band-pass filter (BPF) 71, a low-pass filter (LPF) 72, and a phase comparing section 73. The BPF 71 outputs, to the phase comparing section 73, only the signal element of the frequency f1 in the bias control pilot signal among the monitor signal output from the monitoring section 5. The phase comparing section 73 inputs the bias control pilot signal output from the bias control pilot signal and the monitor signal filtered with the BPF 71 and outputs a voltage depending on the phase difference of these two signals.

The bias control signal output from the phase comparing signal 73 is smoothed with the LPF 72 and is then input to the bias applying section 4.

The amplitude control pilot signal transmitting section 8 is constituted with an oscillating section 81 and an amplifying section 83. The oscillating section 81 generates the amplitude control pilot signal of frequency f2 and then outputs this signal to the amplitude control section 9 and amplifying section 83. The amplitude control pilot signal amplified with the amplifying section 83 is output to the bias applying section 4.

The amplitude control section 9 is constituted with a BPF 91, an LPF 92, and a phase comparing section 93. The BPF 91 outputs, to the phase comparing section 93, only the signal element of frequency f2 of the amplitude control pilot signal among the monitor signal output from the monitoring section 5. The phase comparing section 93 inputs the amplitude control pilot signal output from the amplitude control pilot signal transmitting section 8 and the monitor signal filtered with the BPF 91 and outputs a voltage depending on the phase difference of these signals.

The amplitude control signal output from the phase comparing section 93 is smoothed with the LPF 92 and is then input to the modulator driving section 3.

A bit rate of the transmitting signal is sufficiently higher than the high-band cutoff frequency of the PD 92 and the monitor signal output from the PD 52 is the current which is proportional to the average value of the signal light output of the MZ modulator 2. The frequency f1 of the bias control pilot signal and the frequency f2 of the-amplitude control pilot signal are sufficiently lower than the high-band cutoff frequency of the PD 52, the signal applied to the MZ modulator 2 or the bias voltage is modulated with the frequency f1 or f2 of the pilot signal, and when the modulated element of the pilot signal is included in the output light of the MZ modulator 2, the monitor signal output from the PD 52 also includes the element modulated with the pilot signal.

Bias Control Loop

First, the bias control loop will be described. The bias control loop is constituted with the bias control pilot signal transmitting section 6, modulator driving section 3, MZ modulator 2, monitoring section 5, bias control section 7 and bias applying section 4.

The DC bias Vmz applied to the MZ modulator 2 varies in accordance with the signal input to the amplifying section 43. In the bias control loop, the DC bias Vmz is controlled to become equal to the operational voltage Vop by feeding back a difference between the DC bias Vmz and the operational voltage Vop to the amplifying section 43.

The element of frequency f of the envelope of the drive signal corresponding to the H input of the transmitting signal and the element of frequency f of the envelope of the drive signal corresponding to the L input of the transmitting signal are applied in the reverse phase by modulating the amplitude control signal of the modulator driver with the frequency f.

When the DC bias Vmz is higher than the operational voltage Vop (Vmz>Vop), the envelope (frequency f) of the drive signal corresponding to the H input corresponds to decreasing part (−1) of static characteristic of the modulator, while the envelope (frequency −f) of the drive signal corresponding to the L input corresponds to increasing part (+1) of static characteristic of the modulator as illustrated in FIG. 18.

Accordingly, since the envelope (frequency −f) corresponding to the H input of the optical output waveform and the envelope (frequency −f) corresponding to the L input of the optical output waveform are in the in-phase condition, an element of the frequency f (frequency −f) appears in the average value thereof.

On the other hand, when the DC bias Vmz is lower than the operational voltage Vop (Vmz<Vop), the envelope (frequency f) of the drive signal corresponding to the H input corresponds to increasing part (+1) of static characteristic of the modulator, while the envelope (frequency −f) of the drive signal corresponding to the L input corresponds to decreasing part (−1) of static characteristic of the modulator as illustrated in FIG. 19.

Accordingly, since the envelope (frequency f) corresponding to the H input of the optical output waveform and the envelope (frequency f) corresponding to the L input of the optical output waveform are in the in-phase condition, an element of frequency f (frequency f) appears in the average value thereof.

Therefore, since a signal element of the sign depending on the difference between the DC bias Vmz and operational voltage Vop appears in the average value of the optical output waveform and the signal element varies depending on the difference between Vmz and Vop by modulating the amplitude control signal of the modulator driver with the frequency f, the voltage Vmz can be controlled to become equal to Vop through the feedback control.

The bias control loop will be described below with reference to FIG. 1.

The oscillating section 61 generates the bias control pilot signal of frequency f1 to input to the phase comparing section 73 and polarity switching section 62. The bias control pilot signal input to the polarity switching section 62 is inverted in the polarity as required, amplified with the amplifying section 63 and is mixed, in the mixing section 35, with the amplitude control signal output from the amplitude control section 9.

An amplitude of output signal of the modulator driver 31 is controlled with the signal applied to the amplitude control terminal. Since the bias control pilot signal of frequency f1 is also input to the amplitude control terminal of the modulator driver 31, the amplitude modulation element of frequency f1 is included to the envelope of the output signal amplitude of the modulator driver 31.

An output signal of the MZ modulator 2 branched by the branching section 51 is converted to an electrical signal with the PD 52, amplified with the amplifying section 53 and output as the monitor signal. However, the element of frequency f1 included in the monitor signal is different depending on the relationship between the DC bias Vmz and operational voltage Vop.

When the DC bias Vmz is not equal to the operational voltage Vop, since the maximum and minimum voltages of the modulator drive signal are deviated from the bottom and peak voltages of the modulator characteristic as illustrated in FIG. 18 (Vmz>Vop) and FIG. 19 (Vmz<Vop), the element of frequency f1 is included in the average value of the optical output waveform and the element of frequency f1 is also included in the output current of the PD 52.

Since the element of frequency f1 included in the output current of the PD 52 varies, as described above, in the polarity depending on the direction of deviation of Vmz for Vop and the amplitude proportional to amount of deviation of Vmz for Vop, the optimum DC bias can be obtained by the feedback control of the DC bias Vmz depending on the intensity of the element of frequency f1.

An output current of the PD 52 is converted in current/voltage with the amplifying section 53 to eliminate the element of the frequency other than frequency f1 with the BPF 71. Thereafter, the phase of this output current is compared, in the phase comparing section 73, with the bias control pilot signal of frequency f1 output from the oscillating section 61.

The phase comparing section 73 outputs a voltage of the polarity and amplitude depending on the amount and direction of deviation of Vmz for Vop. This output voltage is then smoothed with the LPF 72. Thereafter, this output voltage is mixed with the amplitude control pilot signal output from the amplitude control pilot signal outputting section 8 and the mixed signal is then input to the amplifying section 43.

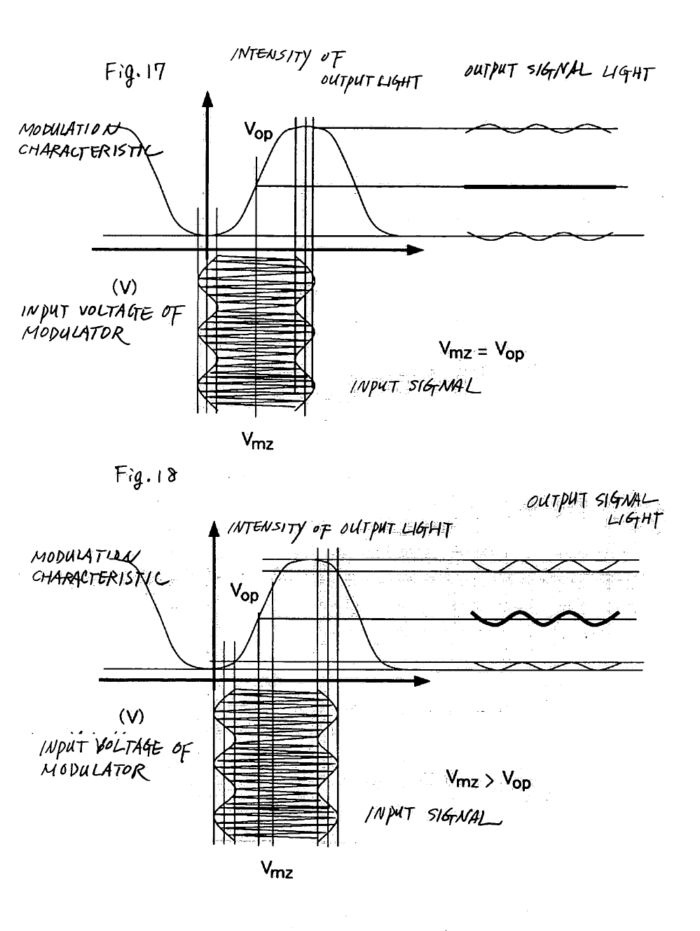

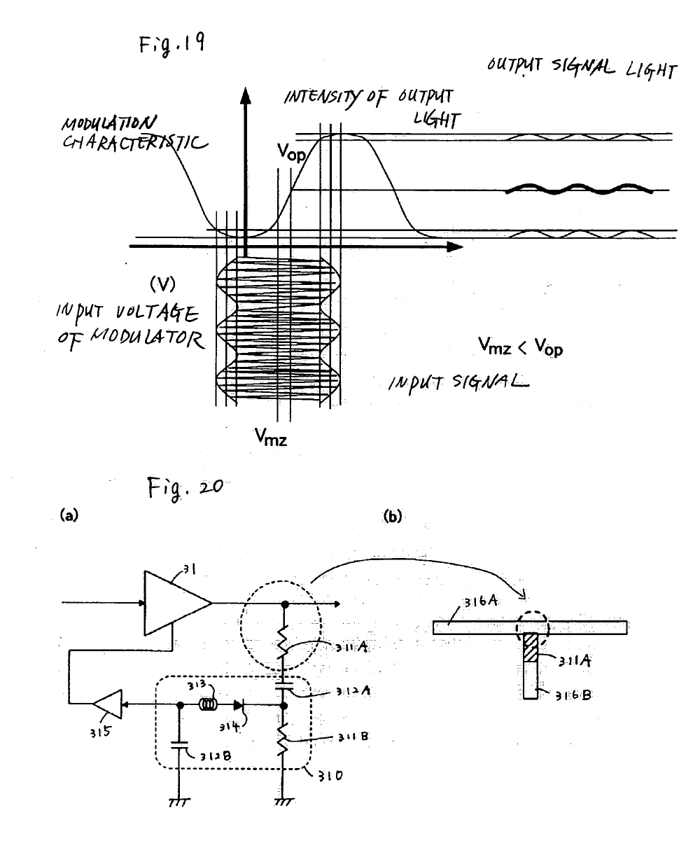

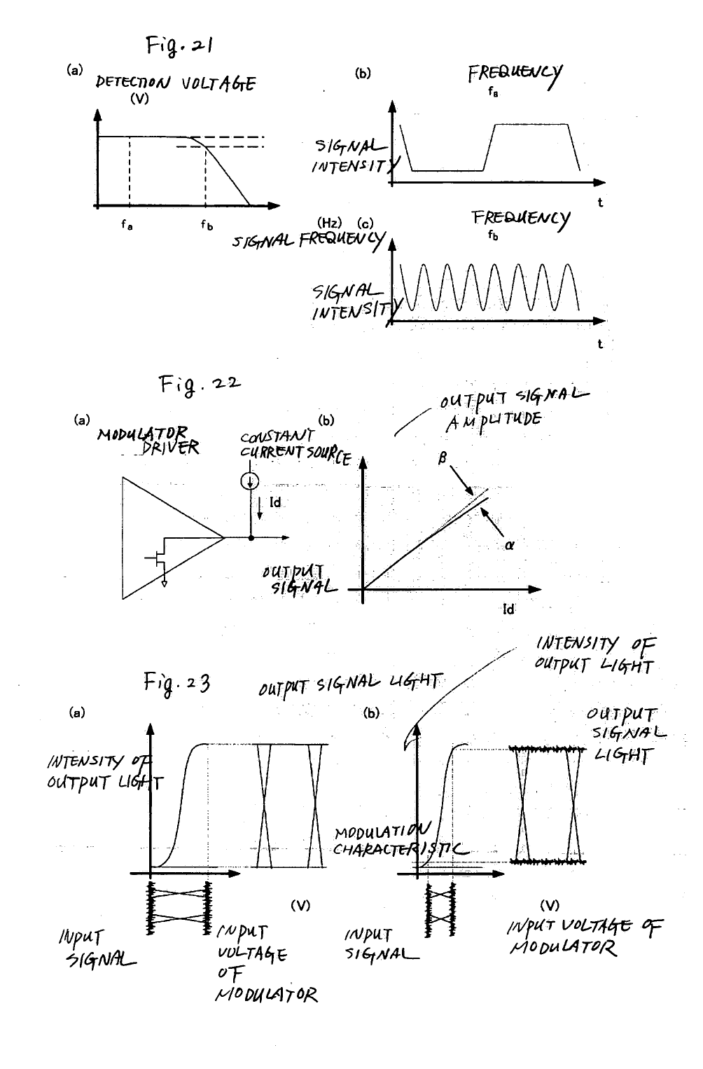

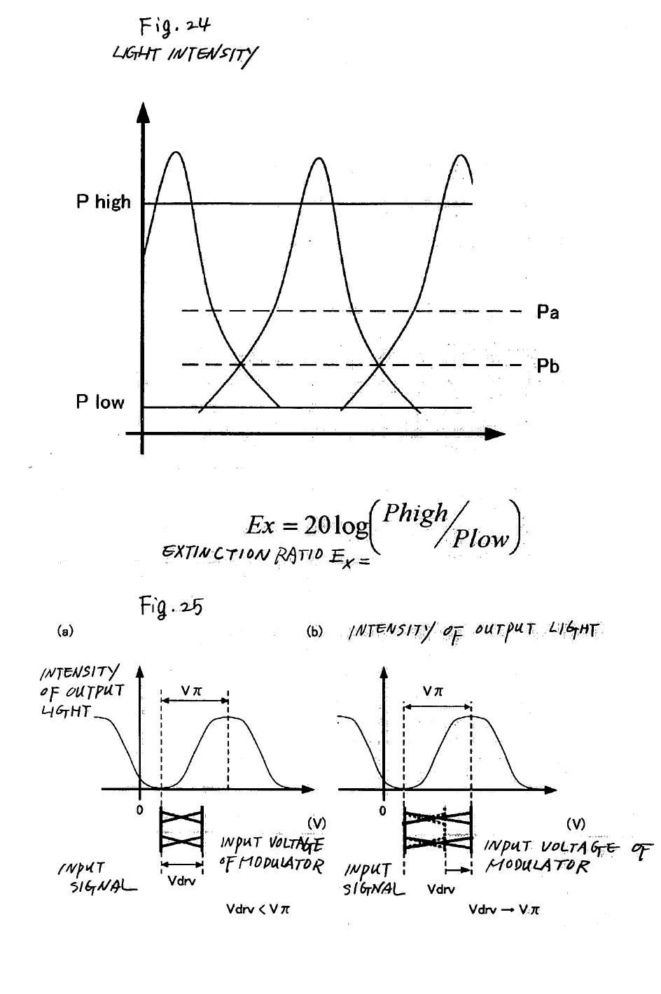

Meanwhile, when the DC bias Vmz is equal to the operational voltage Vop of the MZ modulator 2, the maximum and minimum voltages of the modulator drive signal correspond to the bottom and peak voltages of the modulator characteristic as illustrated in FIG. 17. Since the elements of frequency f1 or f2 appearing on the envelopes of the maximum intensity and minimum intensity of the output signal light are in the inverse phase conditions, the output light waveforms are in the symmetrical condition. Therefore, the element of frequency f1 does not appear in the average value of the output light waveform and the element of frequency f1 does not appear in the output current of the PD 52.

Accordingly, since the element of frequency f1 input to the phase comparing section 73 from the BPF 71 becomes zero (0), an output of the phase comparing section 73 depending on difference between Vmz and Vop also becomes zero (0). In this case, only the amplitude control pilot signal output from the amplitude control pilot signal outputting section 8 and the output of the phase comparing section 73 which is not related to difference between the Vmz and Vop are input to the amplifying section 43 from the mixing section 45 of the bias applying section 4.

When the polarity of bias control pilot signal is set with the polarity switching section 62 for the feedback of the bias voltage Vmz through the route of the MZ modulator 2, phase comparing section 73 and MZ modulator 2, the voltage Vmz can be stabilized when the DC bias Vmz becomes equal to the operational voltage Vop with the constitution described above. Thereby, the DC bias can be set to the optimum value for the modulation characteristic of the MZ modulator 2 and extinction ratio of the signal light output from the MZ modulator 2 can be raised.

In the description of the bias control loop, an output amplitude Vdrv of the modulator driver is set equal to Vπ, but the output amplitude Vdrv of the modulator driver is not always required to be equal to Vπ.

Namely, even when the Vdrv is not equal to Vπ, the stable point exists in the bias control loop and the DC bias Vmz becomes equal to the operational voltage Vop at this stable point. In this case, the voltages corresponding to the H input and L input of the transmitting signal do not always correspond to the peak and bottom values of the modulation characteristic. However, since Vdrv can be set equal to Vπ through the amplitude control which will be described later, the extinction ratio of the signal light output from the MZ modulator 2 can be raised.

Amplitude Control Loop

Next, the amplitude control loop will be described. The amplitude control loop is constituted with the amplitude control pilot signal transmitting section 8, bias applying section 4, modulator driving section 3, MZ modulator 2, monitoring section 5 and amplitude control section 9.

An output amplitude Vdrv of the modulation signal applied to the MZ modulator 2 from the modulator driver 31 is varied with the signal input to the amplitude control terminal of the modulator driver 31 from the mixing section 35. In the amplitude control loop, the output amplitude Vdrv can be controlled to become equal to Vπ through the feedback of the value corresponding to the difference between the output amplitude Vdrv and Vπ to the amplitude control terminal input of the modulator driver 31.

The DC bias voltage of the MZ modulator 2 is applied via the bias tee 41 from the amplifying section 43. When the element of frequency f is included in the input of the amplifying section 43, the DC bias voltage of the MZ modulator 2 also includes the element of frequency f.

When the signal modulated with frequency f is included in the input of the amplifying section 43, the bias voltage of the MZ modulator 2 is modulated with frequency f with the amplifying section 43 and bias tee 41 and the element of frequency f included in the envelope corresponding to the H input of the transmitting signal among the envelopes of the drive signal for driving the MZ modulator 2 and the element of frequency f included in the envelope corresponding to the L input of the transmitting signal are in the in-phase relationship.

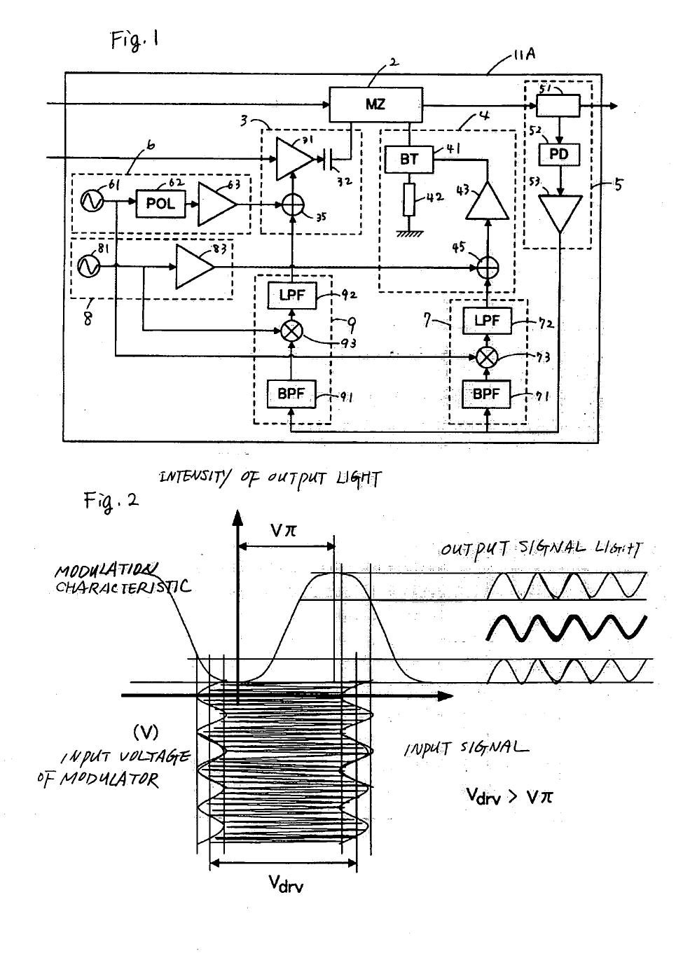

When the output amplitude Vdrv of the modulation signal is larger than Vπ (Vdrv>Vπ), the envelope (frequency f) of the drive signal corresponding to the H input and the envelope (frequency f) of the drive signal corresponding to the L input correspond to decreasing part (−1) of static characteristic of the modulator as illustrated in FIG. 2.

Accordingly, since the envelope (frequency −f) corresponding to the H input of the optical output waveform and the envelope (frequency −f) corresponding to the L input of the optical output waveform are in the in-phase condition, the element of frequency f (frequency −f) appears in the average value thereof.

On the other hand, when the output amplitude Vdrv is smaller than VTπ (Vdrv<Vπ), both envelope (frequency f) of the drive signal corresponding to the H input and envelope (frequency f) of the drive signal corresponding to the L input correspond to the increasing part (+1) of static characteristic of the modulator as illustrated in FIG. 3.

Accordingly, since the envelope (frequency f) corresponding to the H input of the optical output waveform and the envelope (frequency f) corresponding to the L input of the optical output waveform are in the in-phase state, the element of frequency f (frequency f) appears in the average value thereof.

Namely, when the element of frequency f is added to the input of the amplifying section 43, a signal element of the sign depending on a difference between the output amplitude Vdrv of the modulation signal and Vπ appears in the average value of the optical output waveform and an amplitude of the signal element varies depending on a difference between Vdrv and Vπ. Therefore, the output amplitude Vdrv can be controlled to become equal to Vπ through the feedback control.

The amplitude control loop will be described below with reference to FIG. 1.

The oscillating section 81 generates an amplitude control pilot signal of frequency f2 and inputs this pilot signal to the phase comparing section 93 and amplifying section 83. The amplitude control pilot signal amplified with the amplifying section 83 is mixed in the mixing section 45 with a bias control signal output from the bias control section 7 and is then input to the amplifying section 43 of the bias applying section 4.

Since the element of frequency f2 of the amplitude control pilot signal is included in the input of the amplifying section 43, the DC bias applied to the MZ modulator 2 includes the element of frequency f2. Accordingly, the element of frequency f2 is superimposed in the in-phase condition to the envelope corresponding to the H input of the optical output waveform and the envelope corresponding to the L input of the optical output waveform.

An output signal of the MZ modulator 2 branched by the branching section 51 is converted to an electrical signal with the PD 52, amplified with the amplifier 53 and is then output as the monitor signal. However, the element of frequency f2 included in the monitor signal is varied in accordance with the relationship between the output amplitude Vdrv of the modulator driver 31 and Vπ.

When the output amplitude Vdrv is larger than Vπ(Vdrv>Vπ), since the maximum and minimum voltages of the modulator drive signal are deviated to the external side of the bottom and peak voltages of the modulator characteristic even when the bias voltage Vmz is equal to the operational voltage Vop as illustrated in FIG. 2, the element of frequency f2 is included to the average value of the optical output waveform and the element of frequency f2 is also included to the output current of the PD 52.

Since the element of frequency f2 included in the output current of PD 52 varies in the polarity depending on the deviating direction of Vdrv for Vπ and in the amplitude proportional to the deviation of Vdrv for Vπ, the output amplitude Vdrv of the drive signal output from the modulator driver 31 can be controlled to the optimum amplitude through the feedback control of the intensity of the signal applied to the amplitude control terminal of the modulator driver 31 depending on the intensity of the element of frequency f2.

An output current of the PD 52 is current/voltage-controlled with the amplifying section 53 and is subjected to elimination of the element of the frequency other than f2 by the BPF 92. Thereafter, the phase of this output current is compared, in the phase comparing section 93, with the amplitude control pilot signal of frequency f2 output from the oscillating section 81.

The phase comparing section 93 outputs a voltage having the polarity and amplitude depending on the amount and direction of deviation of Vdrv for Vπ. This voltage is then smoothed with the LPF 92, thereafter mixed with the bias control pilot signal output from the bias control pilot signal output section 6, and is then input to the amplifying section 43.

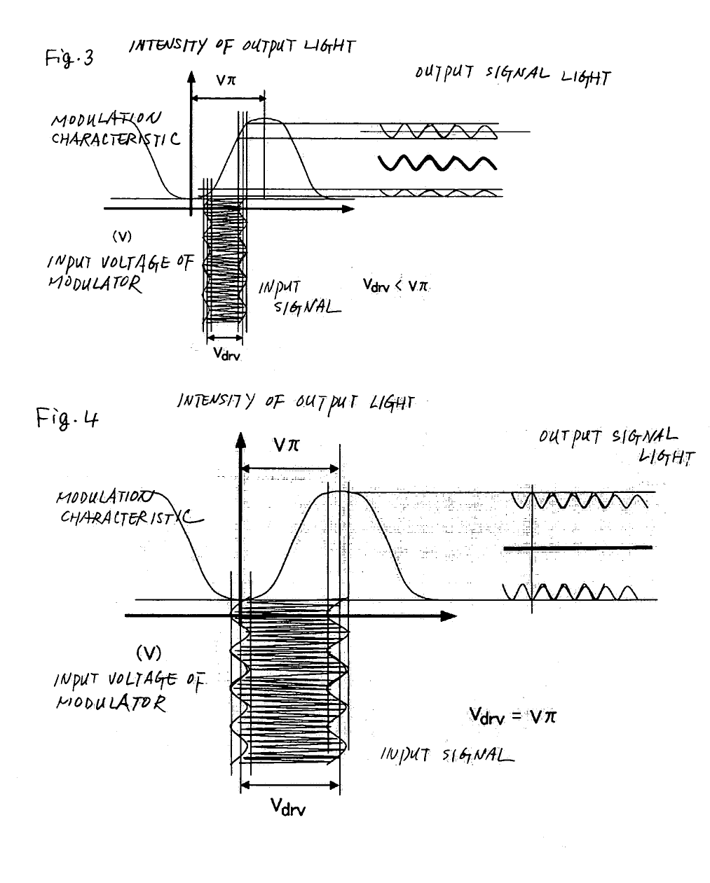

Meanwhile, when the output amplitude Vdrv is equal to Vπ, the maximum and minimum voltages of the modulator drive signal correspond to the bottom and peak voltages of the modulator characteristic as illustrated in FIG. 4. The elements of frequencies f2 and 2f2 appearing, on the envelope corresponding to the H input of the optical output waveform and the envelope corresponding to the L input of the optical output waveform are reversed with each other in the phase and therefore the output optical waveforms are symmetrical. Accordingly, the element of frequency f2 does not appear in the average value of the output optical waveform and the element of frequency f2 does not appear in the output current of the PD 52.

Therefore, since the element of frequency f2 input to the phase comparing section 93 from the BPF 91 becomes zero (0), an output of the phase comparing section 93 depending on the difference between Vdrv and Vπ becomes zero (0). In this case, the signal input to the amplitude control terminal of the modulator driver 31 from the mixing section 35 is only the bias control pilot signal output from t he bias control pilot signal outputting section 6 and the output of the amplitude control section 7 which is not related to the difference between Vdrv and Vπ.

With the constitution described above, the output amplitude Vdrv is stabilized when the Vdrv becomes equal to Vπ. Accordingly, the output amplitude Vdrv can be set to provide the optimum modulation characteristic of the MZ modulator 2 in view of increasing an extinction ratio of the signal light output from the MZ modulator 2.

In above description of the amplitude control loop, the DC bias Vmz is set equal to the operational voltage Vop of the modulator driver, but Vmz is not always required to be equal to Vop.

Namely, when the voltage Vmz is set to a value between the bottom and peak voltages of the modulator characteristic even if the Vmz is different from the Vop, the stable point exists in the amplitude control loop and the output amplitude Vdrv becomes equal to Vπ in this stable point. In this case, the voltages corresponding to the H input and L input of the transmitting signal do not always match with the peak and bottom voltages of the modulator characteristic. However, since Vmz can be set equal to Vop through the bias control described above, an extinction ratio of the signal light output from the MZ modulator 2 can be raised.

As described above, the optical modulating apparatus 11A of the first embodiment includes two control loops of the bias control loop and amplitude control loop and can improve the extinction ratio of the output light of the MZ modulator 2 through optimum control of the bias voltage Vmz of the MZ modulator 2 and the output amplitude Vdrv of the modulator driver 31 to drive the MZ modulator 2.

The monitor signal output from the monitor section 5 performs the control on the basis of only the elements of frequencies f1 and f2 respectively with the BPF 71 and BPF 91 in the bias control section 7 and amplitude control section 9. Therefore, when a difference between Vmz and Vop and a difference between Vdrv and Vπ are within the normal operation range of the control loop, the amplitude control and bias control can be executed simultaneously.

Moreover, since transmission with the signal light having the higher extinction ratio can be realized by utilizing the optical modulating apparatus 11A of the first embodiment as a transmitting terminal of the optical transmission system, a code error rate at the receiving terminal can be lowered.

### Description of the Second Embodiment

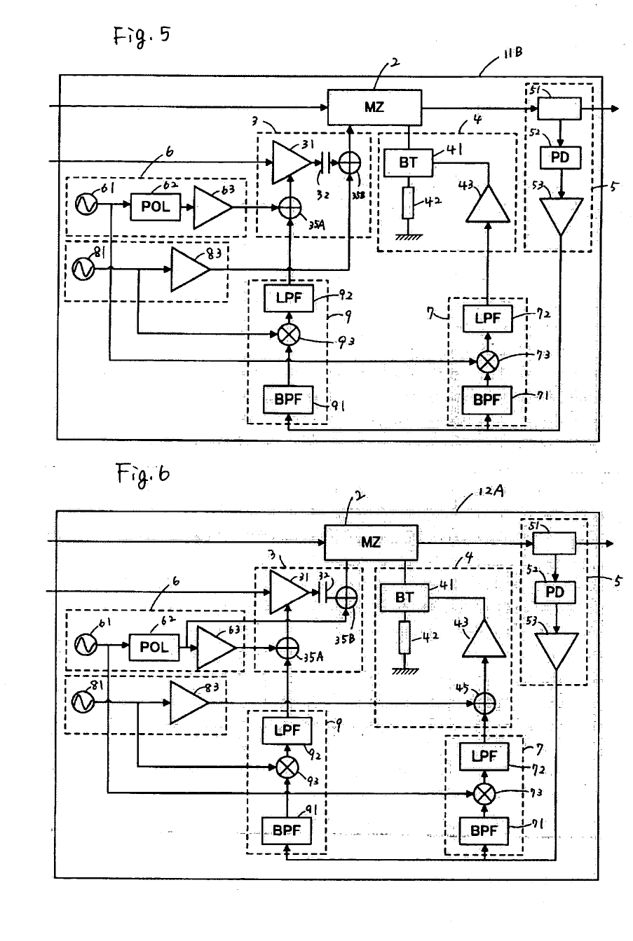

The optical modulating apparatus of the second embodiment of the present invention is illustrated in FIG. 5.

The optical modulating apparatus 1I B of the second embodiment comprises the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 11B of the second embodiment is different from the first embodiment in such a point that an output of the amplitude control pilot signal transmitting section 8 is not input to the bias applying section but to the modulator driving section 3 in order to drive the MZ modulator. The other constitution is identical to the first embodiment.

The modulator driving section 3 comprises the modulator driver 31, capacitor 32, mixing sections 35A and 35B. The mixing section 35A mixes the amplitude control signal output from the amplitude control section 9 and the bias control pilot signal output from the bias control pilot signal transmitting section 6 and then outputs the mixed signal to the amplitude control terminal of the modulator driver 31. The modulator driver 31 amplifies the transmitting signal input from the external side up to the amplitude enough for driving the MZ modulator 2 and also performs the amplitude modulation with the signal input to the amplitude control terminal. The mixing section 35B mixes the AC element of the modulator driver 31 and the amplitude control pilot signal output from the amplitude control pilot signal transmitting section 8 and then inputs the mixed signal to the MZ modulator 2.

The bias applying section 4 is constituted with the bias tee 41, terminating section 42 and amplifying section 43. The terminating section 42 terminates the drive signal applied to the electrode of the MZ modulator 2 with the modulator driver 31. The bias voltage is applied to the MZ modulator 2 from the output of the amplifying section 43 and the bias tee 41.

Next, operations of the optical modulating apparatus 11B of the second embodiment will be described.

Operations of the bias control loop of the optical modulating apparatus 11B of the second embodiment are identical to that of the first embodiment. Namely, the bias control pilot signal of frequency f1 output from the bias control pilot signal transmitting section 6 is input to the amplitude control input of the modulator driver 31 and the bias voltage is controlled with the bias control section 7 on the basis of the element of frequency f1 included in the monitor signal output from the monitor section 5.

The amplitude control loop of the second embodiment is constituted with the amplitude control pilot signal transmitting section 8, modulator driving section 3, MZ modulator 2, monitor section 5 and amplitude control section 9.

Operation of the amplitude control loop of the optical modulating apparatus 11B of the second embodiment is identical to the operation of amplitude control loop of the optical modulating apparatus of the first embodiment in such a point that the element of frequency f2 included in the envelop corresponding to the H input of the transmitting signal among the envelopes of the drive signal to drive the MZ modulator 2 is in the in-phase condition as the element of frequency f2 included in the envelope corresponding to the L input of the transmitting signal when the frequency of the amplitude control pilot signal is f2. However, only difference is that the amplitude control pilot signal is applied from the electrode in the side of the modulator driver 31 of the MZ modulator 2.

The output amplitude Vdrv of the modulation signal applied to the MZ modulator 2 from the modulator driver 31 varies depending on the signal input to the amplitude control terminal of the modulator driver 31 from the mixing section 35. In the amplitude control loop, the output amplitude Vdrv is controlled to become equal to Vπ through the feedback control of a value corresponding to the difference between the output amplitude Vdrv and Vπ to the amplitude control terminal input of the modulator driver 31.

The modulation signal applied to the MZ modulator 2 from the modulator driver 31 is input only in the AC element to the mixing section through the capacitor 32, mixed with the amplitude control pilot signal and is then output. Since the amplitude control pilot signal and the output signal of the modulator driver 31 are mixed in the mixing section 35B in the stage after the capacitor 32, the envelope corresponding to the H input of the transmitting signal and the envelop corresponding to the L input of the transmitting signal among the envelopes of the drive signal for driving the MZ modulator 2 include the element of frequency f2 and these are in the in-phase relationship.

The amplitude control loop will be described with reference to FIG. 5.

The oscillating section 81 generates the amplitude control pilot signal of frequency f2 and inputs this pilot signal to the phase comparing section 93 and amplifying section 83. The amplitude control pilot signal amplified with the amplifying section 83 is mixed, in the mixing section 35B, with the AC element in the output of the modulator driver 31 output from the capacitor 32 and is then input to the electrode in the side of the modulator driver 31 of the MZ modulator 2. Accordingly, the elements of frequency f2 are superimposed under the in-phase condition to the envelope corresponding to the H input of the optical output waveform and the envelope corresponding to the L input of the optical output waveform.

Like the first embodiment, an output signal of the MZ modulator 2 branched by the branching section 51 is converted to an electrical signal with the PD 52, amplified with the amplifying section 53 and is then output as the monitor signal. However, the element of frequency f2 included in the monitor signal differs depending on the relationship between the output amplitude Vdrv of the modulator driver 31 and Vπ.

When the output amplitude Vdrv is larger than Vπ (Vdrv>Vπ), since the maximum and minimum voltages of the modulator drive signal are deviated to the external side of the bottom and peak voltages of the modulator characteristic even when the bias voltage Vmz is equal to the operational voltage Vop as illustrated in FIG. 2, the element of frequency f2 is includes in the average value of the optical output waveform and the element of frequency f2 is also included in the output current of the PD 52.

Like the first embodiment, since the element of frequency f2 includes in the output current of the PD 52 varies in the polarity depending on the direction of deviation of Vdrv for Vπ and the amplitude proportional to the amount of deviation of Vdrv for Vπ, the output amplitude Vdrv of the drive signal output from the modulator driver 31 can be controlled to the optimum amplitude through the feedback control of intensity of the signal to be added to the amplitude control terminal of the modulator driver 31 depending on intensity of the element of frequency f2.

The output current of the PD 52 is current/voltage-controlled with the amplifying section 53 and is subjected to elimination of the element of the frequency other than f2 with the BPF 91. Thereafter, this output signal is compared, by the phase comparing section 93, in the phase with the amplitude control pilot signal of frequency f2 output from the oscillating section 81.

The phase comparing section 93 outputs the voltage of the polarity and amplitude depending on the amount and direction of deviation of Vdrv for Vπ. This output voltage is smoothed with the LPF 92 and is mixed, thereafter, by the mixing section 45, with the bias control pilot signal output from the bias control pilot signal outputting section 6 and is then input to the amplifying section 43.

Meanwhile, when the output amplitude Vdrv is equal to Vπ, the maximum and minimum voltages of the modulator drive signal correspond to the bottom and peak voltages of the modulator characteristic as illustrated in FIG. 4. Since the elements of frequencies f2 or 2f2 appearing on the envelope corresponding to the H input of the optical output waveform and the envelope corresponding to the L input of the optical output waveform are inverted in the phase with each other, the output optical waveforms are symmetrical. Accordingly, the element of frequency f2 does not appear in the average value of the output optical waveform and the element of frequency f2 does not appear in the output current of the PD 52.

Therefore, since the element of frequency f2 input to the phase comparing section 93 from the BPF 91 becomes zero (0), an output of the phase comparing section 93 depending on a difference between Vdrv and Vπ becomes zero (0). In this case, only the amplitude control pilot signal output from the amplitude control pilot signal outputting section 6 and the output of the phase comparing section 73 which is not related to difference between Vdrv and Vπ are input to the amplifying section 43 with the mixing section 45.

Like the first embodiment, Vmz is not always required to be equal to Vop in the second embodiment.

That is, even when Vmz is different from Vop, if Vmz is within the bottom and peak voltages of the modulator characteristic, a stable point exists in the amplitude control loop and the output amplitude Vdrv becomes equal to Vπ at this stable point. In this case, the voltages corresponding to the H input and L input of the transmitting signal do not always match with the peak and bottom voltages of the modulator characteristic. However, since Vmz can be set equal to Vop through the bias control as described above, an extinction ratio of the signal light output from the MZ modulator 2 can be raised.

As described above, the optical modulating apparatus 11B of the second embodiment includes the two control loops of bias control loop and amplitude control loop and can improve the extinction ratio of the output light of the MZ modulator 2 through the optimum control of the output amplitude Vdrv of the modulator driver 31 to drive the MZ modulator 2.

The monitor signal output from the monitor section 5 performs controls on the basis of only the elements of frequencies f1 and f2 respectively with the BPF 71 and BPF 91 in the bias control section 7 and amplitude control section 9. Accordingly, these amplitude control and bias control may be conducted simultaneously when difference between Vmz and Vop and difference between Vdrv and Vπ are within the range ensuring the normal operations of the control loops.

Moreover, since transmission with the signal light having a higher extinction ratio may be realized using the optical modulating apparatus 11A of the second embodiment to a transmitting terminal of the optical transmission system, a code error rate at the receiving terminal can be lowered.

### Description of the Third Embodiment

The optical modulating apparatus of the third embodiment of the present invention is illustrated in FIG. 6.

The optical modulating apparatus 12A of the third embodiment is constituted with the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 12A of the third embodiment is constituted to cancel the element of frequency f1 included in the envelope corresponding to any one of the H input or L input of the transmitting signal by adding the bias control pilot signal of frequency f1 to the mixing section 35B in order to mix this pilot signal to the drive signal of the modulator driver 31 including the amplitude modulation element of frequency f1.

Constitutions and operations of the MZ modulator 2, bias applying section 4, monitor section 5, bias control section 7, amplitude control pilot signal transmitting section 8 and amplitude control section 9 are identical to those of the optical modulating apparatus 11A of the first embodiment.

The bias control pilot signal transmitting section 6 is constituted with the oscillating section 61, polarity switching section (POL) 62 and amplifying section 63. The oscillating section 61 generates the bias control pilot signal of frequency f1 and outputs this signal to the bias control section 7 and polarity switching section 62. The bias control pilot signal input to the polarity switching section 62 is inverted in the polarity as required and is then output to the amplifying section 63. Moreover, this pilot signal is then input to the mixing section 35B. The bias control pilot signal amplified with the amplifying section 63 is output to the modulator driving section 3.

The modulator driving section 3 is constituted with the modulator driver 31, capacitor 32, mixing sections 35A and 35B. The mixing section 35A mixes the amplitude control signal output from the amplitude control section 9 and the bias control pilot signal output from the bias control pilot signal transmitting section 6 and then outputs the mixed signal to the amplitude control terminal of the modulator driver 31. The modulator driver 31 amplifies the transmitting signal input from the external side up to the adequate amplitude for driving the MZ modulator 2 and performs the amplitude modulation with the signal input to the amplitude control terminal. The mixing section 35B mixes the AC element of the modulator driver 31 and the bias control pilot signal output from the polarity switching section 62 of the bias control pilot signal transmitting section 6 and then inputs the mixed signal to the MZ modulator 2.

Next, operations of the optical modulating apparatus 12A of the third embodiment will be described.

As in the case of the first embodiment, the transmitting signal input from the external side is amplified, with the modulator driver 31, up to the adequate amplitude for driving the MZ modulator 2 and is then input to the MZ modulator 2 through the capacitor 32. Moreover, a bias voltage is applied to the MZ modulator 2 with the amplifying section 43 and bias tee 41.

The CW light input from the external side is modulated with the MZ modulator 2 in accordance with the drive signal input from the modulator driving section 3 and is then output. The output light of the MZ modulator 2 is branched to the output of the optical modulating apparatus 11A and the input of the PD 52. The optical signal input to the PD 52 is converted to an electrical signal and is then output to the amplifying section 53.

The control loop of the optical modulating apparatus 12A of the third embodiment is constituted with two control loop systems of the bias control loop using the bias control pilot signal and the amplitude control loop using the amplitude control pilot signal.

Operations of the amplitude control loop of the optical modulating apparatus 12A of the third embodiment are similar to that of the first embodiment. That is, the element of frequency f2 is superimposed to the bias voltage by mixing the amplitude control pilot signal of frequency f2 output from the amplitude control pilot signal transmitting section 8 and the bias control signal and then applying the mixed signal to the bias voltage of the amplifying section 43 and the amplitude control section 9 inputs the element of frequency f2 included in the monitor signal output from the monitor section 5 to the amplitude control terminal of the modulator driver 31.

Here, the control operation for making equal the modulator driver Vdrv to Vπ by adding the bias control pilot signal to the mixing section 35B to cancel the element of frequency f1 included in the envelope corresponding to any one of the H input or L input of the transmitting signal will be described below.

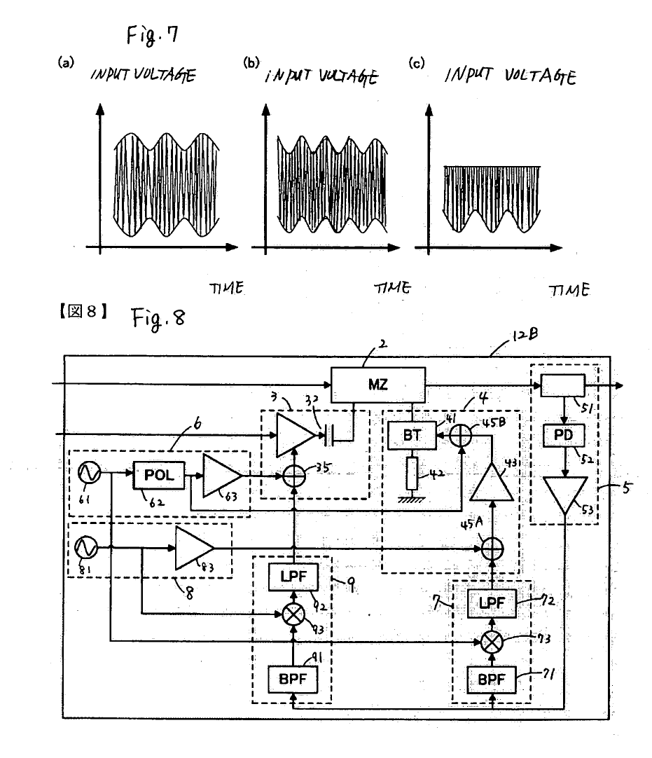

When the bias control pilot signal of frequency f1 is input to the amplitude control terminal of the modulator driver 31 from the mixing section 35A, the amplitude of the modulator driving signal output to the mixing section 35B through the capacitor 32 is modulated with the frequency f1 and the modulator drive signal of FIG. 17 and the envelopes corresponding to the H input and L input of the transmitting signal illustrated in FIG. 7(a) include the element of frequency f1 and are inverted in the phase relationship thereof.

The element of frequency f1 of the envelope corresponding to the H input or L input of the transmitting signal is cancelled by mixing, with the mixing section 35B, the bias control pilot signal output from the polarity switching section 62 and the modulator drive signal output from the capacitor 32 and the modulator drive signal of the waveform illustrated in FIG. 7(c), for example, is applied to the drive electrode of the MZ modulator 2 from the mixing section 35B.

The envelope corresponding to the H input or L input to be cancelled among the envelopes of the transmitting signal can be selected with the polarity switching section 62.

When the element of frequency f1 is included only in one of the H input and L input of the modulator drive signal, the input voltage including the element of frequency f1 is fixed through the control to the peak or bottom voltage of the modulation characteristic as illustrated, for example, in FIG. 25(a) via the bias control loop formed of the MZ modulator 2, monitor section 5, bias control section 7 and bias applying section 4.

Moreover, the bias control and amplitude control can be realized to increasing the extinction ratio of the signal waveform by making equal the output amplitude Vdrv of the modulator driver to Vπ, as illustrated in FIG. 25(b), by conducting the amplitude control through the amplitude control loop formed of the MZ modulator 2, monitor section 5, amplitude control section 9 and modulator driving section 3 under the condition, for example illustrated in FIG. 25(a), that the input voltage including the element of frequency f1 is fixed through the control to the peak or bottom voltage of the modulation characteristic.

That is, since the Vdrv is controlled to become equal to Vπ with the amplitude control loop and the input voltage including the element of frequency f1 is fixed through the control to the peak or bottom voltage of the modulation characteristic with the bias control loop, Vdrv is controlled to become equal to Vπ and the DC bias Vmz is controlled so that both H input and L input of the modulator drive signal become the peak or bottom voltage of the modulation characteristic.

Accordingly, the single voltage of the modulator drive signal is controlled to become closer to the bottom voltage of the modulator characteristic in comparison with the case where the element of frequency f1 is superimposed to both sides of the envelope of the modulator drive signal. The extinction ratio of the signal waveform is expressed with a ratio of Plow and Phigh as expressed with the formula (1). However, since Plow can be lowered by making the single voltage of the modulator drive signal closer to the bottom voltage expressed with the formula (1), the extinction ratio can be more increased.

### Description of the Fourth Embodiment

The optical modulating apparatus of the fourth embodiment of the present invention is illustrated in FIG. 8.

The optical modulating apparatus 12B of the fourth embodiment is constituted with the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 12B of the fourth embodiment is constituted to cancel the element of frequency f1 included in the envelope corresponding to any one of the H input or L input of the transmitting signal by adding the bias control pilot signal of frequency f1 to the mixing section 45B and then applying the element of frequency f1 to the bias voltage.

Constitutions and operations of the MZ modulator 2, monitor section 5, bias control pilot signal transmitting section 6, bias control section 7, amplitude control pilot signal transmitting section 8 and amplitude control section 9 are identical to that of the optical modulating apparatus 12A of the third embodiment. Moreover, constitution and operation of the modulator driving section 3 are identical to that of the optical modulating apparatus 11A of the first embodiment.

The bias applying section 4 is constituted with the bias tee 41, terminating section 42, amplifying section 43 and mixing sections 45A, 45B. The terminating section 42 terminates the drive signal applied to the MZ modulator 2 from the modulator driver 31. The bias voltage is applied to the MZ modulator 2 from the output of the mixing section 45B and the bias tee 41. The mixing section 45A mixes the amplitude control pilot signal output from the amplitude control pilot signal transmitting section 8 and the bias control signal output from the bias control section 7 and then outputs the mixed signal to the amplifying section 43. The mixing section 45B mixes the bias control signal output from the polarity switching section 6 and the output of the amplifying section 43 and then outputs the mixed signal to the bias tee 41.

The optical modulating apparatus 12B of the fourth embodiment is different from the optical modulating apparatus 12A of the third embodiment in the point that the bias control pilot signal output from the polarity switching section 6 is not mixed with the output of the capacitor 32 of the modulator driving section 3 but with the output of the amplifying section 43 in the bias applying section 4 with the mixing section 45B. The other constitution is identical to that of the third embodiment.

Operations of the optical modulating apparatus 12B of the fourth embodiment will be described next.

Operations of the amplitude control loop of the optical modulating apparatus 12B of the fourth embodiment are identical to that of the third embodiment. Namely, the element of frequency f2 is superimposed to the bias voltage and the amplitude control section 9 inputs the element of frequency f2 included in the monitor signal output from the monitor section 5 to the amplitude control terminal of the modulator driver 31.

Operations of the bias control loop of the optical modulating apparatus 12B of the fourth embodiment is identical to that of the amplitude control loop of the optical modulating apparatus 12A of the third embodiment in the point that the element of frequency f1 included in the envelope corresponding to any one of the H input or L input of the transmitting signal but is different therefrom in the point that the bias control pilot signal is applied from the electrode in the side of modulator driver 31 of the MZ modulator 2.

When the bias control pilot signal of frequency f1 is mixed with the output of the amplifying section 43 with the mixing section 45B, the element of frequency f1 is included in the bias voltage output from the MZ modulator 2 through the bias tee 41. The envelopes corresponding to the H input and L input of the transmitting signal of the modulator drive signal of FIG. 17 and the drive signal applied from the modulator driver 31 illustrated in FIG. 7(a) are including the element of frequency f1 and are inverted in the phase relationship.

The element of frequency f1 of the envelope corresponding to the H input or L input of the transmitting signal is cancelled by mixing the element of frequency f1 to the bias voltage and the modulator drive signal in the waveform illustrated, for example, in FIG. 7(c) is applied to the drive electrode of the MZ modulator 2 with the mixing section 35B.

Operations of bias control and amplitude control for increasing the extinction ratio of the signal waveform by canceling the element of frequency f1 included in one envelope of the drive signal are identical to that of the optical modulating apparatus 12A of the third embodiment.

### Description of the Fifth Embodiment

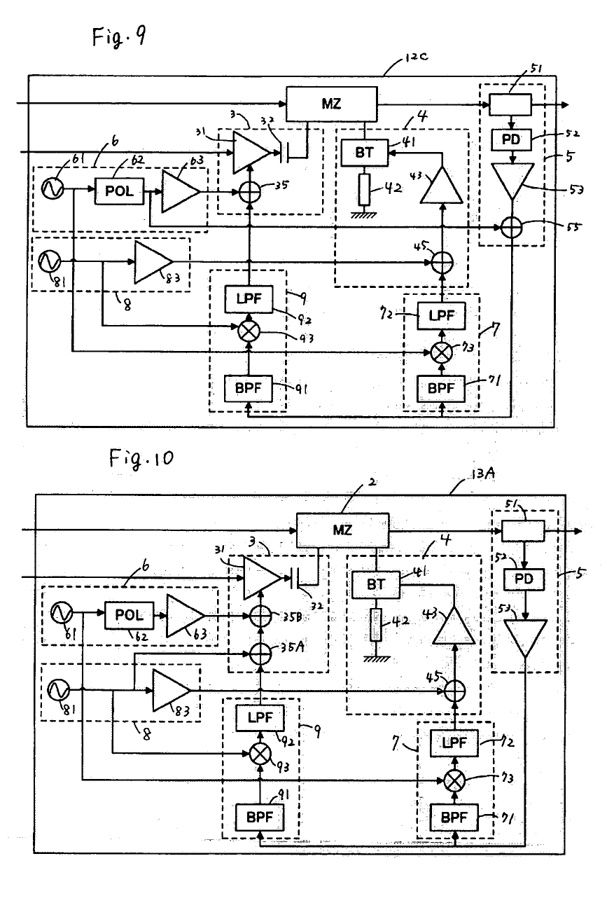

The optical modulating apparatus of the fifth embodiment of the present invention is illustrated in FIG. 9.

The optical modulating apparatus 12C of the fifth embodiment is constituted with the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 12C of the fifth embodiment is constituted to cancel the element of frequency f1 included in the envelope corresponding to any one of the H input or L input of the transmitting signal, which has been output as the monitor signal with the PD 51 and amplifying section 53, by adding the bias control pilot signal of frequency f1 to the mixing section 55 and then adding the element of frequency f1 to the monitor signal.

Constitutions and operations of the MZ modulator 2, bias control pilot signal transmitting section 6, bias control section 7, amplitude control pilot signal transmitting section 8 and amplitude control section 9 are identical to that of the optical modulating apparatus 12A of the third embodiment. Moreover, constitutions and operations of the modulator driving section 3 and bias applying section 4 are identical to that of the optical modulating apparatus 11A of the first embodiment.

The monitor section 5 is constituted with the branching section 51, PD 52, amplifying section 53 and mixing section 55. The branching section 51 branches the output light of the MZ modulator 2 to the output of the optical modulating apparatus 12C and the input of the PD 52, while the branched output light of the MZ modulator 2 is converted to an electrical signal with the PD 52. The monitor signal output from the PD 52 is amplified with the amplifying section 53. The mixing section 55 mixes the bias control pilot signal output from the polarity switching section 62 and the output of the amplifying section 53 and outputs the mixed signal. The output of the mixing section 55 is then input to the bias control section 7 and amplitude control section 9.

Operations of the amplitude control loop of the optical modulating apparatus 12C of the fifth embodiment are identical to that of the third embodiment. Namely, the element of frequency f1 is superimposed to the bias voltage by mixing the amplitude control pilot signal of frequency f2 output from the amplitude control pilot signal transmitting section 8 with the bias control signal and then applying the mixed signal to bias voltage of the amplifying section 43 and the amplitude control section 9 inputs the element of frequency f2 included in the monitor signal output from the monitor section 5 to the amplitude control terminal of t he modulator driver 31.

Operations of the bias control loop of the optical modulating apparatus 12C of the fifth embodiment will be described next.

The envelopes corresponding to the H input and L input of the transmitting signal of the modulator drive signal of FIG. 17 and the drive signal applied from the modulator driver 31 illustrated in FIG. 7(a) include the element of frequency f1 and are in the reversed in the phase relationship. The envelopes corresponding to the H input and L input of the transmitting signal of the output light of the MZ modulator 2 are also including the element of frequency f1 and the electrical signal output from the PD 52 also includes the element of frequency f1.

Here, the bias control pilot signal output from the polarity switching section 62 is mixed with the electrical signal output from the amplifying section 53 in the subsequent stage of the PD 52. When the bias control pilot signal has the phase and amplitude for canceling any one of the signal elements of frequency f1 corresponding to the H input and L input of the transmitting signal, the monitor signal output from the monitor section 5 includes only the signal element of frequency f1 corresponding to any one of the H input and L input of the transmitting signal and is then input to the bias control section 7.

Since the bias control section 7 controls the bias voltage to minimize the signal element of frequency f1 included in the input monitor signal, the transmitting input voltage where the signal element of frequency f1 is included in the monitor signal, namely the voltage of the H input or L input corresponding to the output of the polarity switching section 62 is fixed through the control to t he peak or bottom voltage of the modulation characteristic.

Operations for bias control and amplitude control to increase the extinction ratio of the signal waveform by fixing the voltage of the H input or L input corresponding to the output of the polarity switching section 62 to the peak or bottom voltage of the modulation characteristic are identical to that of the optical modulating apparatus 12A of the third embodiment.

### Description of the Sixth Embodiment

The optical modulating apparatus of the sixth embodiment of the present invention is illustrated in FIG. 10.

The optical modulating apparatus 13A of the sixth embodiment is constituted with the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 13A of the sixth embodiment can set the driver output amplitude Vdrv to the desired voltage value near to Vπ by applying the amplitude control pilot signal of frequency f2 to the mixing section 35A and then shifting the operation converging point of the amplitude control loop passing through the modulator driving section 3, MZ modulator 2, monitor section 5 and amplitude control section 7.

Constitutions and operations of the MZ modulator 2, bias applying section 4, monitor section 5, bias control pilot signal transmitting section 6, bias control section 7 and amplitude control section 9 are identical to that of the optical modulating apparatus 11A of the first embodiment.

The amplitude control pilot signal transmitting section 8 is constituted with the oscillating section 81 and amplifying section 83. The oscillating section 81 generates the amplitude control pilot signal of frequency f2 and then outputs this pilot signal to the amplitude control section 9, mixing section 35A and amplifying section 83. The amplitude control pilot signal amplified with the amplifying section 83 is then output to the bias applying section 4.

The modulator driving section 3 is constituted with the modulator driver 31, capacitor 32, mixing sections 35A and 35B. The mixing section 35A mixes the amplitude control signal output from the amplitude control section 9 and the amplitude control pilot signal output from the amplitude control pilot signal transmitting section 8. The mixing section 35B mixes an output of the mixing section 35A and the bias control pilot signal output from the amplifying section 6 and outputs the mixed signal to the amplitude control terminal of the modulator driver 31. The modulator driver 31 amplifies the transmitting signal input from the external side up to the adequate amplitude for driving the MZ modulator 2 and also performs the amplitude modulation with the signal input to the amplitude control terminal.

Next, operations of the optical modulating apparatus 13A of the sixth embodiment will be described.

Operations of the bias control loop of the optical modulating apparatus 13A of the sixth embodiment are identical to that of the first embodiment. Namely, the bias control pilot signal of frequency f1 output from the bias control pilot signal transmitting section 6 is applied to the amplitude control input of the modulator driver 31 and the bias control section 7 performs the bias voltage control on the basis of the element of frequency f1 included in the monitor signal output from the monitor section 5.

The amplitude control loop of the sixth embodiment is constituted with the amplitude control pilot signal transmitting section 8, modulator driving section 3, MZ modulator 2, monitor section 5 and amplitude control section 9.

In the amplitude control loop of the sixth embodiment, the element of frequency f2 is applied in the in-phase condition to both envelopes of the drive signal of the MZ modulator 2 by applying the amplitude control pilot signal element of frequency f2 to the bias voltage. The elements of frequency f2 are applied in the inverted-phase condition to the envelopes of the drive signal of the MZ modulator 2 by applying the amplitude control pilot signal element of frequency f2 to the amplitude control terminal of the modulator driver 31 through the mixing section 35A.

Accordingly, intensity of the element of frequency f2 included in the envelope corresponding to the H input of the drive signal of the MZ modulator and intensity of the element of frequency f2 included in the envelope corresponding to the L input can be varied by changing intensity of the amplitude control pilot signal element to be applied to the amplitude control terminal of the modulator driver 31 through the mixing section 35A.

Since the output amplitude Vdrv is controlled with the amplitude control section 9 by adjusting intensity of the amplitude control signal output from the amplitude control section 9 in order to reduce the element of frequency f2 included in the monitor signal output from the monitor section 5, a value of the output amplitude Vdrv which makes minimum the element of frequency f2 included in the monitor signal is varied by changing intensity of the element of frequency f2 included in the envelope corresponding to the H input of the drive signal and intensity of the element of frequency f2 included in the envelope corresponding to the L input.

Accordingly, the output amplitude Vdrv can be controlled not only to the value of Vπ but also to the desired value by changing intensity of the amplitude control pilot signal element applied to the mixing section 35A.

Thereby, an inter-symbol interference can be controlled, for example, by making the output amplitude Vdrv larger than Vπ in place of making equal to Vπ.

### Description of the Seventh Embodiment

The optical modulating apparatus 11 of the seventh embodiment of the present invention is illustrated in FIG. 11.

The optical modulating apparatus 13B of the seventh embodiment is constituted with the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 13B of the seventh embodiment is capable of shifting the operation converging point of the amplitude control loop to set the driver output amplitude Vdrv to the desired voltage near to Vπ by applying the amplitude control pilot signal of frequency f2 to the mixing section 55 and then applying the element of frequency f2 to the monitor signal.

Constitutions and operations of the MZ modulator 2, bias applying section 4, bias control pilot signal transmitting section 6, bias control section 7, amplitude control pilot signal transmitting section 8 and amplitude control section 9 are identical to that of the optical modulating apparatus 13A of the sixth embodiment. Moreover, constitution and operation of the modulator driving section 3 are also identical to that of the optical modulating apparatus 11A of the first embodiment.

The monitor section 5 is constituted with the branching section 51, PD 52, amplifying section 53 and mixing section 55. The branching section 51 branches the output light of the MZ modulator 2 to the output of optical modulating apparatus 13B and input of PD 52 and the branched output light of the MZ modulator 2 is converted to an electrical signal with the PD 52. The monitor signal output from the PD 52 is amplified with the amplifying section 53. The mixing section 55 mixes the amplitude control pilot signal output from the oscillating section 81 and an output of the amplifying section 53 and outputs the mixed signal. An output of the mixing section 55 is then input to the bias control section 7 and amplitude control section 9.

Next, operations of amplitude control loop of the optical modulating apparatus 13B of the seventh embodiment will be described below.

The amplitude control loop of the seventh embodiment is constituted with the amplitude control pilot signal transmitting section 8, bias applying section 4, modulator driving section 3, MZ modulator 2, monitor section 5 and amplitude control section 9.

In the operations of amplitude control loop, the elements of frequency f2 are applied in the in-phase condition to the envelopes of the drive signal corresponding to the H input and L input of the transmitting signal by applying the amplitude control pilot signal to the mixing section 45 to include the element of frequency f2 to the DC bias voltage. The envelopes corresponding to the H input and L input of the transmitting signal in the output light of the MZ modulator 2 also include the element of frequency f2 and the electrical signal output from the PD 52 also includes the element of frequency f2.

Here, the amplitude control pilot signal output from the oscillating section 81 is mixed with an electrical signal output from the amplifying section 53 in the subsequent stage of the PD 52. Since the output amplitude Vdrv is controlled with the amplifying control section 9 by adjusting intensity of the amplitude control signal output from the amplitude control section 9 to reduce the element of frequency f2 included in the monitor signal output from the monitor section 5, a value of the output amplitude Vdrv which minimizes the element of frequency f2 included in the monitor signal is changed by applying the amplitude control pilot signal of frequency f2 to the output signal of the amplifying section 53 in view of changing the phase and amplitude of the element of frequency f2 input to the amplitude control section.

Accordingly, like the sixth embodiment, the output embodiment Vdrv can be controlled not only to Vπ but also to the desired value by changing intensity of the amplitude control pilot signal element applied to the mixing section 55. As a result, an inter-symbol interference can be controlled, for example, by making the output amplitude Vdrv larger than Vπ in place of making equal to Vπ.

### Description of the Eighth Embodiment

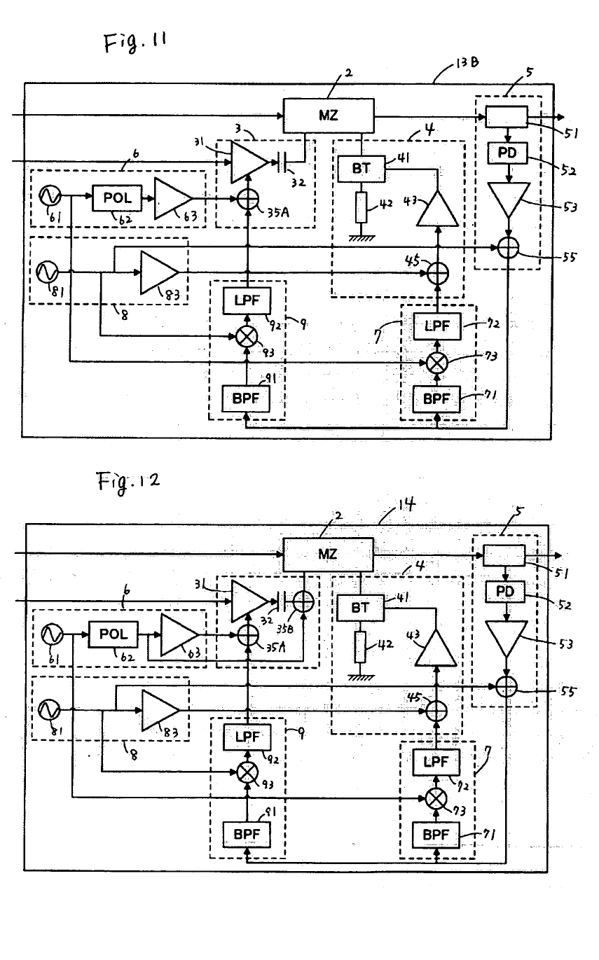

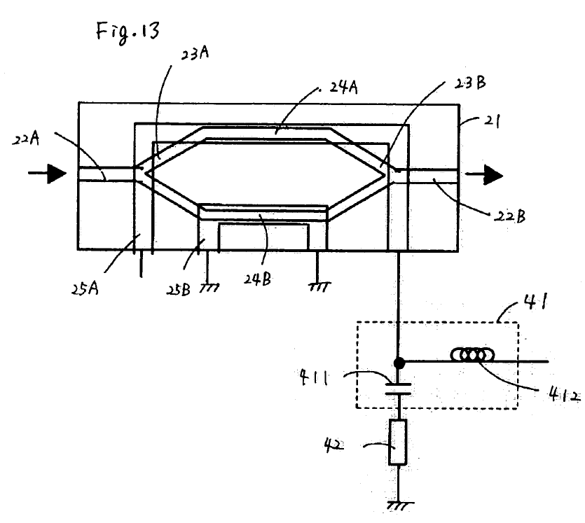

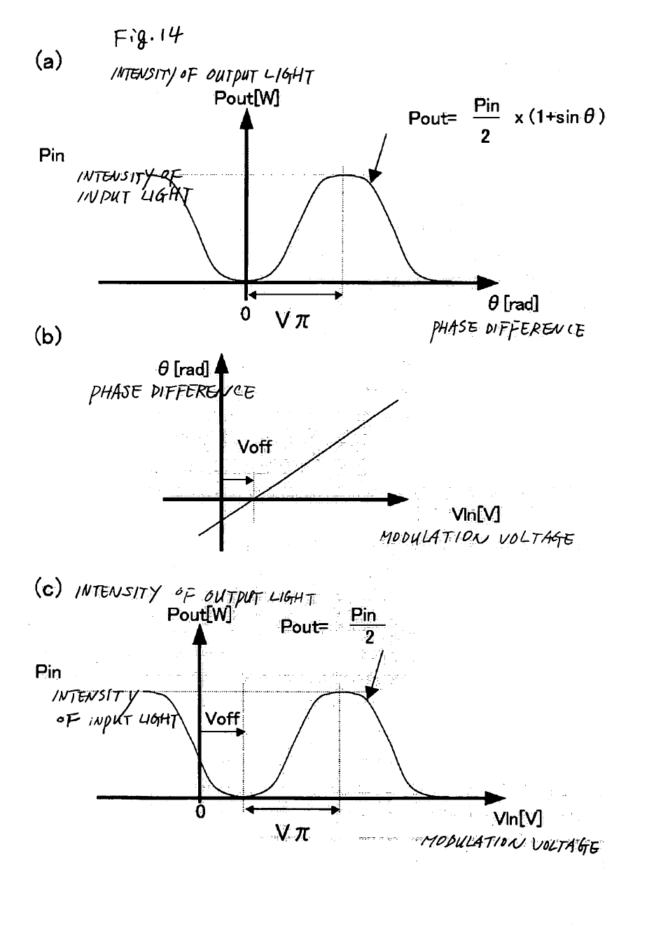

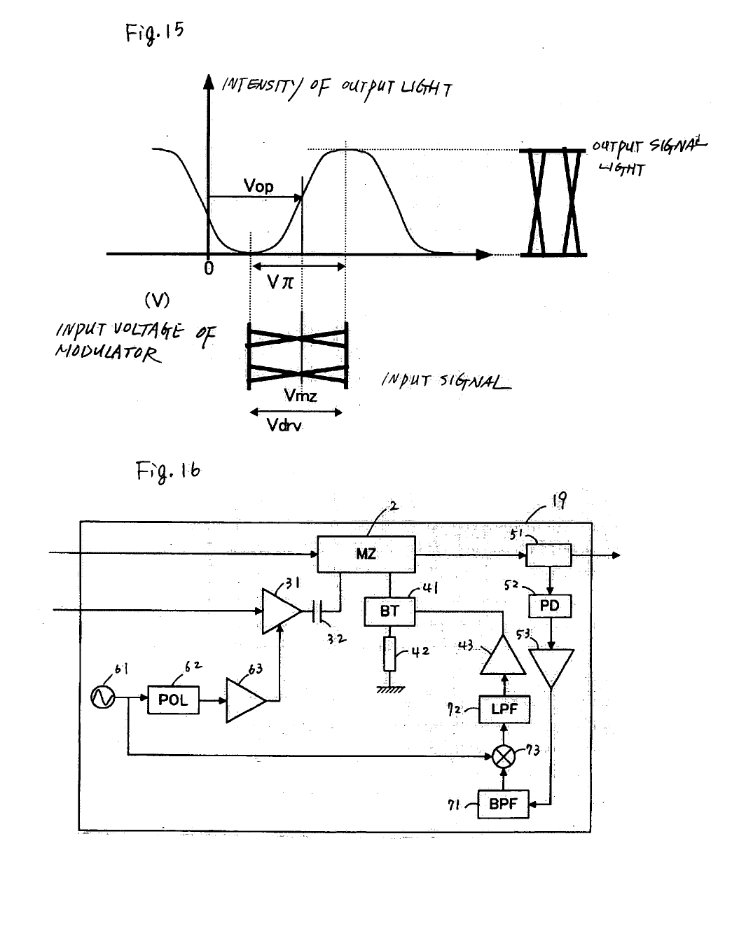

The optical modulating apparatus of the eighth embodiment of the present invention is illustrated in FIG. 12.

The optical modulating apparatus 14A of the eighth embodiment is constituted with the MZ modulator 2, modulator driving section 3, bias applying section 4, monitor section 5, bias control pilot signal transmitting section 6, bias control section 7, amplitude control pilot signal transmitting section 8 and amplitude control section 9.

The optical modulating apparatus 14A of the eighth embodiment is constituted to cancel, like the optical modulating apparatus 12A of the third embodiment, the element of frequency f1 included in the single envelope of the transmitting signal by mixing the bias control pilot signal of frequency f2 with the drive signal and to shift, like the optical modulating apparatus 13B of the seventh embodiment, the operation converging point of the amplitude control loop by mixing the amplitude control pilot signal of frequency f2 with the monitor signal.

Constitutions and operations of the MZ modulator 2, modulator driving section 3, bias applying section 4, bias control pilot signal transmitting section 6, bias control section 7 are identical to that of the optical modulating apparatus of the third embodiment. Moreover, constitutions and operations of the monitor section 5, amplitude control pilot signal transmitting section 8 and amplitude control section 9 are identical to that of the optical modulating apparatus 12A of the third embodiment.

The optical modulating apparatus 14A of the eighth embodiment cancels, like the optical modulating apparatus 12A of the third embodiment, the element of frequency f1 included in the single envelope of the transmitting signal controls and controls, with the bias control loop, the input voltage including the element of frequency f1, as illustrated, for example, in FIG. 25(a), to fix this input voltage to the peak or bottom voltage of the modulation characteristic.

The amplitude control is conducted with the amplitude control loop formed of the MZ modulator 2, monitor section 5, amplitude control section 9 and modulator driving section 3 under the condition that the input side voltage including the element of frequency f1 is fixed through the control to the peak or bottom voltage of the modulation characteristic, for example, in the condition illustrated in FIG. 25(a).

Here, like the optical modulating apparatus 13B of the seventh embodiment, the operating converging point of the amplitude control loop can be shifted and the output amplitude Vdrv of the modulator driver can be controlled not only to Vπ but also to the desired value by mixing the amplitude control pilot signal of frequency f2 to the monitor signal.

Accordingly, the voltage in the single side of the modulator driving signal can be controlled to be shifted more closely to the bottom voltage of the modulator characteristic and the extinction ratio can be raised to the higher value like the optical modulating apparatus 12A of the third embodiment, in comparison with the case where the element of frequency f1 is superimposed to both envelopes of the modulator drive signal.

Moreover, like the optical modulating apparatus 13B of the seventh embodiment, an inter-symbol interference can be controlled, for example, by making the output amplitude Vdrv larger than Vπ in place of making this amplitude equal to Vπ.

Others

As described above, according to the present invention, the DC bias Vmz and output amplitude Vdrv can be controlled to increase extinction ratio and control inter-symbol interference by applying the bias control pilot signal and amplitude control pilot signal to the drive signal of the MZ modulator 2.

In the second to eighth embodiments, the element of frequency f2 has been applied, like the first embodiment, to the envelope of the output signal light by applying the amplitude control pilot signal to the mixing section 45 of the bias applying section 4 but the element of frequency f2 can be applied, like the second embodiment, to the envelope of the output signal light for the amplitude control by applying the amplitude control pilot signal from the preceding stage of the capacitor 32 of the modulator driving section 3.

Moreover, in the eights embodiment, the element of frequency f1 included in the single envelope of the transmitting signal has been cancelled, like the third embodiment, by applying the bias control pilot signal to the preceding stage of the capacitor 32 of the modulator driving section 3. However, it is also possible that the element of frequency f1 included in the single envelope of the transmitting signal is cancelled and the input voltage including the element of frequency f1 is fixed, through the control, to the peak or bottom voltage of the modulation characteristic by applying, like the fourth embodiment, the bias control pilot signal to the bias voltage and by applying, like the fifth embodiment, the bias control pilot signal to the output of amplifying section 53 to obtain the monitor signal.

Moreover, in the eighth embodiment, the amplitude control pilot signal of frequency f2 has been mixed, like the seventh embodiment, to the monitor signal. However, the operation converging point of the amplitude control loop can be shifted, like the sixth embodiment, and the output amplitude Vdrv of the modulator driver can be controlled not only to Vπ but also to the desired voltage value by applying, like the sixth embodiment, the amplitude control pilot signal to the amplitude control terminal of the modulator driver 31.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. An optical modulating apparatus comprising;
a modulating section operable to modulate an input light and to output an optical signal;
a first signal transmitting section operable to output a signal of a first frequency;
a second signal transmitting section operable to output a signal of a second frequency;
a modulator driving section operable to receive transmitting data and said signal of the first frequency, to output a drive signal based on said transmitting data to said modulating section, and to superimpose said signal of the first frequency onto said drive signal so that said signal of the first frequency appears in reverse phase on two envelopes of said drive signal;
a bias applying section operable to receive said signal of the second frequency and to output a bias upon which said signal of the second frequency is superimposed to said modulating section; and
a monitoring section operable to branch an output light of said modulating section and to output a monitor signal converted to an electrical signal, wherein
said bias is controlled based on said first frequency included in said monitor signal and an amplitude of said drive signal is controlled based on said second frequency included in said monitor signal.

2. The optical modulating apparatus according to claim 1, wherein said modulator driving section receives said signal of the first frequency and mixes said signal of the first frequency to said drive signal in order to cancel said first frequency in a single side of envelopes of said drive signal.

3. The optical modulator according to the claim 1, wherein said first signal transmitting section outputs said signal of the first frequency to said bias applying section and said bias applying section modulates said bias with said first frequency in order to cancel said first frequency in a single side of envelopes of said drive signal.

4. The optical modulating apparatus according to the claim 1, wherein said first signal transmitting section outputs said signal of the first frequency to said monitor section and said monitor section mixes said signal of the first frequency to said monitor signal in order to cancel said first frequency in a single side of envelopes of said optical modulating means.

5. The optical modulating apparatus according to the claims 4, wherein said second signal transmitting section outputs said signal of the second frequency to said modulator driving section, said modulator driving section modulates said drive signal with said second frequency and provides an output, and an amplitude of said drive signal is controlled by controlling intensity of said signal of the second frequency input to said modulator driving section.

6. The optical modulating apparatus according to the claims 4, wherein said second signal transmitting section outputs said signal of the second frequency to said monitor section, said monitor section mixes said signal of the second frequency to said monitor signal, and an amplitude of said drive signal is controlled by controlling intensity of said signal of the second frequency input to said monitor section.

7. An optical modulating apparatus comprising;
a modulating section operable to modulate an input light and to output an optical signal;
a first signal transmitting section operable to output a signal of a first frequency;
a second signal transmitting section operable to output a signal of a second frequency;
a modulator driving section operable to receive transmitting data and said signal of the first frequency, to output a drive signal based on said transmitting data to said modulator by mixing said drive signal and said signal of the second frequency, and to superimpose said signal of the first frequency to said drive signal so that said signal of the first frequency appears in reverse phase on two envelopes of said drive signal;
a bias applying section operable to output a bias to said modulating section; and
a monitor means operable to branch an output light of said modulating section and to output a monitor signal converted to an electrical signal; wherein
said bias is controlled based on said first frequency included in said monitor signal and an amplitude of said drive signal is controlled based on said second frequency included in said monitor signal.

8. The optical modulating apparatus according to claim 7, wherein said modulator driving section receives said signal of the first frequency and mixes said signal of the first frequency to said drive signal in order to cancel said first frequency in a single side of envelopes of said drive signal.

9. The optical modulator according to the claim 7, wherein said first signal transmitting section outputs said signal of the first frequency to said bias applying section and said bias applying section modulates said bias with said first frequency in order to cancel said first frequency in a single side of envelopes of said drive signal.

10. The optical modulating apparatus according to the claim 7, wherein said first signal transmitting section outputs said signal of the first frequency to said monitor section and said monitor section mixes said signal of the first frequency to said monitor signal in order to cancel said first frequency in a single side of envelopes of said optical modulating means.

11. The optical modulating apparatus according to the claims 10, wherein said second signal transmitting section outputs said signal of the second frequency to said modulator driving section, said modulator driving section modulates said drive signal with said second frequency and provides an output, and an amplitude of said drive signal is controlled by controlling intensity of said signal of the second frequency input to said modulator driving section.

12. The optical modulating apparatus according to the claims 10, wherein said second signal transmitting section outputs said signal of the second frequency to said monitor section, said monitor section mixes said signal of the second frequency to said monitor signal, and an amplitude of said drive signal is controlled by controlling intensity of said signal of the second frequency input to said monitor section.

13. An optical modulating apparatus comprising;
a Mach-Zehnder type modulator operable to modulate an input light and to output an optical signal;
a first signal transmitting section operable to output a signal of a first frequency;
a second signal transmitting section operable to output a signal of a second frequency;
a modulator driving section operable to receive transmitting data and said signal of the first frequency, to output a drive signal based on said transmitting data to said modulator, and to superimpose said signal of the first frequency onto said drive signal so that said signal of the first frequency appears in reverse phase on two envelopes of said drive signal;
a bias applying section operable to input said signal of the second frequency and to output a bias upon which said signal of the second frequency is superimposed to said modulator; and
a monitor means operable to branch an output light of said modulator and to output a monitor signal converted to an electrical signal; wherein
said bias is controlled based on a periodical characteristic of said modulator and said first frequency included in said monitor signal and an amplitude of said drive signal is controlled based on a periodical characteristic of said modulator and said second frequency included in said monitor signal.

14. The optical modulating apparatus according to claim 13, wherein said modulator driving section receives said signal of the first frequency and mixes said signal of the first frequency to said drive signal in order to cancel said first frequency in a single side of envelopes of said drive signal.

15. The optical modulator according to the claim 13, wherein said first signal transmitting section outputs said signal of the first frequency to said bias applying section and said bias applying section modulates said bias with said first frequency in order to cancel said first frequency in a single side of envelopes of said drive signal.

16. The optical modulating apparatus according to the claim 13, wherein said first signal transmitting section outputs said signal of the first frequency to said monitor section and said monitor section mixes said signal of the first frequency to said monitor signal in order to cancel said first frequency in a single side of envelopes of said optical modulating means.

17. The optical modulating apparatus according to the claims 16, wherein said second signal transmitting section outputs said signal of the second frequency to said modulator driving section, said modulator driving section modulates said drive signal with said second frequency and provides an output, and an amplitude of said drive signal is controlled by controlling intensity of said signal of the second frequency input to said modulator driving section.

18. The optical modulating apparatus according to the claims 16, wherein said second signal transmitting section outputs said signal of the second frequency to said monitor section, said monitor section mixes said signal of the second frequency to said monitor signal, and an amplitude of said drive signal is controlled by controlling intensity of said signal of the second frequency input to said monitor section.
